(19) United States
(12) Patent Application Publication
(10) Pub. No.: US 2024/0047109 A1
(43) Pub. Date: Feb. 8, 2024

(54) MAGNETIC CORE AND MAGNETIC COMPONENT

(71) Applicant: TDK CORPORATION, Tokyo (JP)

(72) Inventors: Kazuhiro YOSHIDOME, Tokyo (JP); Kensuke ARA, Tokyo (JP)

(73) Assignee: TDK CORPORATION, Tokyo (JP)

(21) Appl. No.: 18/358,513

(22) Filed: Jul. 25, 2023

(30) Foreign Application Priority Data
Jul. 27, 2022 (JP) 2022-119673

(51) Int. Cl. H01F 3/08

(52) U.S. Cl. CPC H01F 3/08

(57) ABSTRACT

Provided is a magnetic core in which metal magnetic particles occupy an area of 75% to 90% on a cross-section. The metal magnetic particles include first large particles having a crystalline metal material and having a Heywood diameter of 3 μm or more on the cross-section of the magnetic core, and second large particles having a nanocrystal structure or an amorphous structure and having a Heywood diameter of 3 μm or more, and an insulation coating of the first large particles is thicker than an insulation coating of the second large particles.

### BACKGROUND OF THE INVENTION

### 1. Field of the Invention

The present disclosure relates to a magnetic core containing a metal magnetic powder, and a magnetic component including the magnetic core.

### 2. Description of the Related Art

There are known magnetic components such as an inductor, a transformer, and a choke coil which include a magnetic core (dust core) containing a metal magnetic powder and a resin. With respect to the magnetic components, various attempts have been made to improve various characteristics such as magnetic permeability.

For example, JP 2004-197218 A and JP 2004-363466 A disclose that when using a metal magnetic powder obtained by mixing a crystalline alloy powder and an amorphous alloy powder, a packing rate of the metal magnetic powder in the magnetic core is improved and the magnetic permeability or a core loss (magnetic loss) can be improved.

In addition, JP 2011-192729 A discloses that when using two kinds of metal magnetic powders different in a particle size, and adjusting a particle size ratio of the two kinds of metal magnetic powders within a predetermined range, a magnetic core in which a metal magnetic powder is packed at a high density is obtained, and the magnetic permeability is improved.

In recent, a demand for a reduction in size, high efficiency, and energy saving in the magnetic components is increasing, and thus it is required to improve a core loss and DC bias characteristics in a compatible manner.

### CITATION LIST

### Patent Document

Patent Document 1: JP 2004-197218 A
Patent Document 2: JP 2004-363466 A
Patent Document 3: JP 2011-192729 A

### SUMMARY OF THE INVENTION

The present disclosure has been made in view of above circumstances, and an object of exemplary embodiments of the present disclosure is to provide a magnetic core in which a low core loss and good DC bias characteristics are compatible with each other, and a magnetic component including the magnetic core.

To accomplish the object, a magnetic core according to the present disclosure containing: metal magnetic particles, a total area ratio occupied by the metal magnetic particles on a cross-section of the magnetic core is 75% to 90%, the metal magnetic particles include, first large particles having a crystalline metal material and having a Heywood diameter of 3 μm or more on the cross-section of the magnetic core, and second large particles having a nanocrystal structure or an amorphous structure and having a Heywood diameter of 3 μm or more on the cross-section of the magnetic core, and an insulation coating of the first large particles is thicker than an insulation coating of the second large particles.

When the magnetic core has the above-described characteristics, a low core loss and good DC bias characteristics are compatible with each other.

Preferably, T1/T2 is preferably 1.3 to 50, in which an average thickness of the insulation coating of the first large particles is set to T1, and an average thickness of the insulation coating of the second large particles is set to T2.

Preferably, the average thickness T2 of the insulation coating of the second large particles is 5 to 50 nm.

Preferably, the metal magnetic particles include a particle group in which a Heywood diameter on the cross-section of the magnetic core is less than 3 μm, and the particle group in which the Heywood diameter is less than 3 μm includes two or more kinds of small particles having coatings different in composition to each other.

The magnetic core of the present disclosure is applicable to various magnetic components such as an inductor, a transformer, and a choke coil.

### BRIEF DESCRIPTION OF THE DRAWINGS

FIG. 1 is a schematic diagram showing a cross-section of a magnetic core according to an embodiment;

FIG. 2A is a graph showing an example of a particle size distribution of a metal magnetic powder;

FIG. 2B is a graph showing an example of the particle size distribution of the metal magnetic powder;

FIG. 2C is a graph showing an example of the particle size distribution of the metal magnetic powder;

FIG. 3A is an enlarged schematic view of a cross-section of the magnetic core shown in FIG. 1;

FIG. 3B is an enlarged schematic view of a cross-section of a magnetic core according to a second embodiment;

FIG. 4 is a schematic cross-sectional view showing an example of a powder treatment device that is used when forming an insulation coating on small particles; and

FIG. 5 is a cross-sectional view showing an example of a magnetic component according to the present disclosure.

### DETAILED DESCRIPTION OF THE PREFERRED EMBODIMENTS

Hereinafter, the present disclosure is described in detail based on an embodiment shown in the drawings.

### First Embodiment

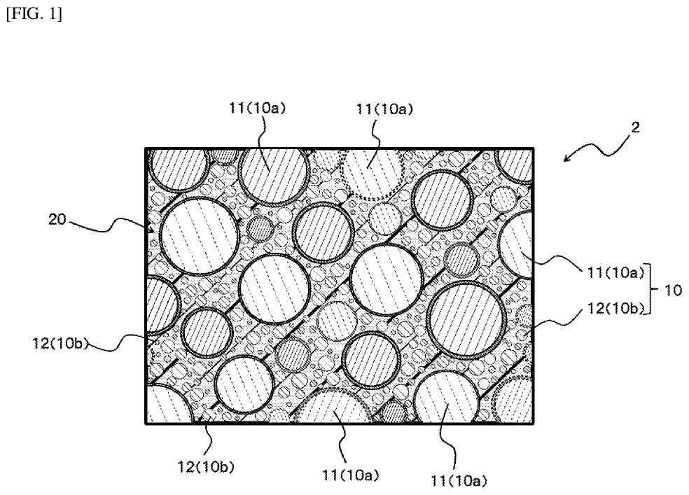

A magnetic core 2 according to this embodiment may maintain a predetermined shape, and an external size or a shape thereof is not particularly limited. As shown in a cross-sectional view of FIG. 1, the magnetic core 2 contains at least metal magnetic particles 10 and a resin 20, and the metal magnetic particles 10 are dispersed in the resin 20. That is, the metal magnetic particles 10 are bound through the resin 20, and thus the magnetic core 2 has a predetermined shape.

A total area ratio A0 occupied by the metal magnetic particles 10 on a cross-section of the magnetic core 2 is 75% to 90%. The total area ratio A0 of the metal magnetic particles 10 corresponds to a packing rate of the metal magnetic particles 10 in the magnetic core 2, and may be calculated by performing analysis on the cross-section of the magnetic core 2 by using an electronic microscope such as a scanning electron microscope (SEM) and a scanning transmission electron microscope (STEM).

For example, observation is performed by dividing any cross-section of the magnetic core 2 into a plurality of continuous fields of view, and an area of each of the metal magnetic particles 10 included in each of the fields of view is measured. Then, the sum of the areas of the metal magnetic particles 10 is divided by a total area of the observed fields of view to calculate the total area ratio A0(%) of the metal magnetic particles 10. In the cross-section analysis, the total area of the fields of view is preferably set to at least 1000000 μm². In addition, in the cross-section analysis, in a case where a cut-out surface (a surface obtained by cutting out and polishing the magnetic core 2) of an observation sample is less than the total area of the fields of view, after analyzing a predetermined cut-out surface, the cut-out surface may be polished again by 100 μm or more, and the cross-section analysis may be performed again to set the total area of the fields of view to 1000000 μm² or more.

The metal magnetic particles 10 contained in the magnetic core 2 are formed from a soft magnetic metal, but may be classified into a plurality of particle groups on the basis of a particle size, a composition, a substance state, or the like. The metal magnetic particles 10 include a first particle group 10a in which a Heywood diameter is 3 μm or more, and preferably further includes a second particle group 10b in which a Heywood diameter is less than 3 μm. Here, the “Heywood diameter” in this embodiment represents a circle equivalent diameter of each of the metal magnetic particles 10 observed on the cross-section of the magnetic core 2. Specifically, an area of each of the metal magnetic particles 10 on the cross-section of the magnetic core 2 is set to S, and the Heywood diameter of each of the metal magnetic particles 10 is expressed by (4S/π)^{1/2}.

In a case where the metal magnetic particles 10 include the first particle group 10a and the second particle group 10b, in the magnetic core 2, a content rate of the first particle group 10a is preferably larger than a content rate of the second particle group 10b. That is, on the cross-section of the magnetic core 2, when a total area ratio occupied by first particle group 10a is set to A1, and a total area ratio occupied by second particle group 10b is set to A2, the area ratio of the metal magnetic particles 10 preferably satisfies a relationship of A1>A2. When the content rate of the first particle group 10a is set to be larger than the content rate of the second particle group 10b, the magnetic permeability of the magnetic core 2 can be improved. Note that, the sum of A1 and A2 becomes the total area ratio A0 of the metal magnetic particles 10 (A1+A2=A0), and A1 and A2 may be measured by a similar method as in A0.

In addition, the metal magnetic particles 10 preferably include two or more particle groups different in an average particle size. For example, the metal magnetic particles 10 may include at least large particles 11 corresponding to the first particle group 10a, but the metal magnetic particles 10 preferably include the large particles 11 and small particles 12, and may include other medium particles 13. The large particles 11, the small particles 12, and the medium particles 13 can be distinguished on the basis of a particle size distribution of the metal magnetic particles 10. The particle size distribution of the metal magnetic particles 10 may be specified by measuring the Heywood diameter of at least 1000 pieces of the metal magnetic particles 10 on any cross-section of the magnetic core 2.

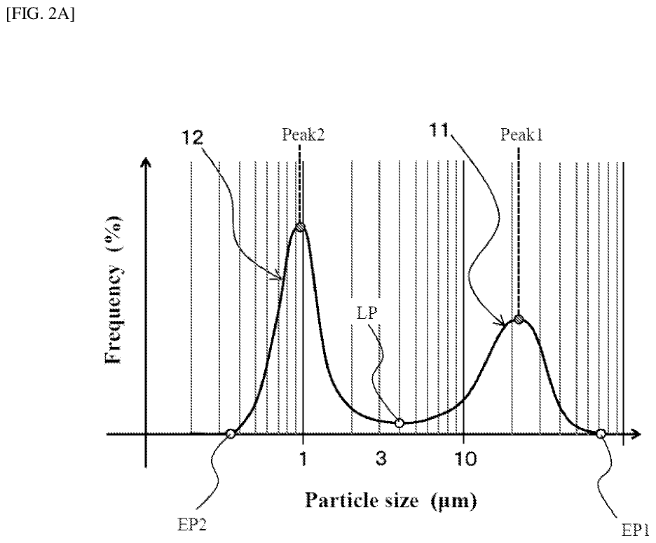

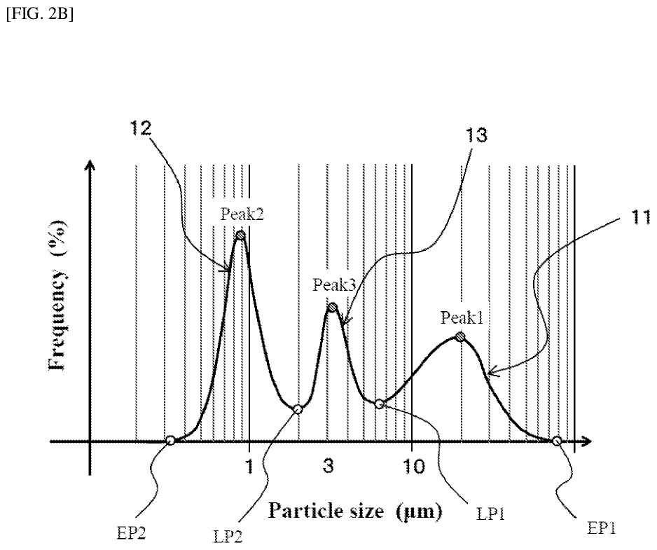

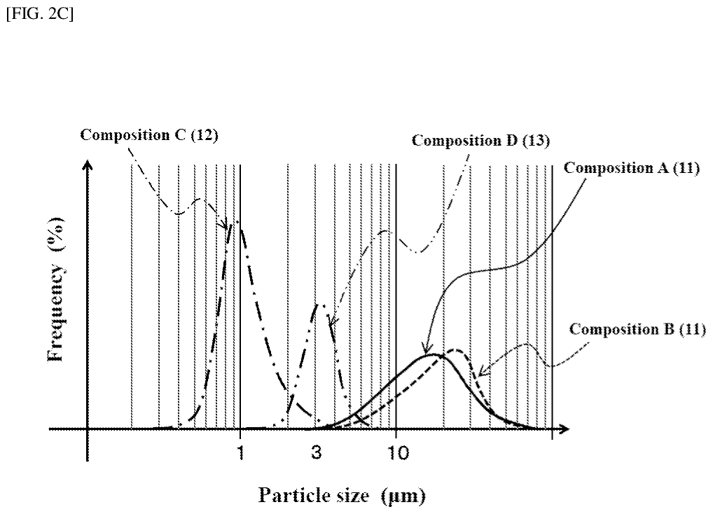

For example, graphs exemplified in FIGS. 2A to 2C are particle size distributions of the metal magnetic particles 10. In the graphs of FIGS. 2A to 2C, the vertical axis represents an area-basis frequency (%), and the horizontal axis is a logarithmic axis representing a particle size (μm) in terms of the Heywood diameter. Note that, the particle size distributions shown in FIGS. 2A to 2C are illustrative only, and the particle size distribution of the metal magnetic particles 10 is not limited to FIGS. 2A to 2C.

In a case where the metal magnetic particles 10 are constituted by two particle groups (large particles and small particles) different in an average particle size, as shown in FIG. 2A, the particle size distribution of the metal magnetic particles 10 has two peaks. In addition, in a case where the metal magnetic particles 10 are constituted by three particle groups (a large particle, a medium particle, and a small particle) different in an average particle size, as shown in FIG. 2B, the particle size distribution of the metal magnetic particles 10 has three peaks.

As shown in FIGS. 2A and 2B, in a case where the particle size distribution of the metal magnetic particles 10 is expressed by a series of distribution curves, a particle group which belongs to a peak located on the largest diameter side (peak located on the rightmost side of the horizontal axis) and in which D20 is 3 μm or more is set as large particles 11, and a particle group which belongs to a peak located on the smallest diameter side (peak located on the leftmost side of the horizontal axis) and in which D80 is less than 3 μm is set as small particles 12. In addition, particles other than the large particles 11 and the small particles 12 are set as medium particles 13.

Here, the “particle group belonging to a peak located on the largest diameter side” represents a particle group included in a range from the bottom (the rightmost end) of the distribution curve to a local minimum point through a peak top point when tracing the distribution curve from the large diameter side (the right side of the graph). That is, in a case of the particle size distribution shown in FIG. 2A, a particle group included in a range from EP1 to LP through Peak 1 corresponds to the “particle group belonging to a peak located on the largest diameter side”. In a case of the particle size distribution shown in FIG. 2B, a particle group included in a range from EP1 to LP1 through Peak 1 corresponds to the “particle group belonging to a peak located on the largest diameter side”.

In addition, D20 represents a Heywood diameter in which an area-basis cumulative frequency is 20%. In the particle size distributions in FIGS. 2A and 2B, D20 of the particle group belonging to Peak 1 is 3 μm or more, and a particle group belonging to Peak 1 corresponds to the large particles 11.

The “particle group belonging to a peak located on the smallest diameter side” represents a particle group included in a range from the bottom (leftmost end) of the distribution curve to a local minimum point through a peak top point when tracing the distribution curve from the small diameter side (the left side of the graph). That is, in a case of the particle size distribution shown in FIG. 2A, a particle group included in a range from EP2 to LP through Peak 2 corresponds to the “particle group belonging to a peak located on the smallest diameter side”. In addition, in a case of the particle size distribution shown in FIG. 2B, a particle group included in a range from EP2 to LP2 through Peak 2 corresponds to the “particle group belonging to a peak located on the smallest diameter side”.

In addition, D80 represents a Heywood diameter in which an area-basis cumulative frequency becomes 80%. In the particle size distributions in FIGS. 2A and 2B, D80 of a particle group belonging to Peak 2 is less than 3 μm, and the particle group belonging to Peak 2 corresponds to the small particles 12.

Note that, in the particle size distribution shown in FIG. 2B, a particle group from LP1 to LP2 through Peak 3 is a particle group belonging to Peak 3. In the particle group belonging to Peak 3, D20 is less than 3 μm and D80 is 3 μm or more. That is, the particle group belonging to Peak 3 corresponds to medium particles 13 which correspond to neither the large particles 11 nor the small particles 12.

In a case where the metal magnetic particles 10 include two or more particle groups different in an average particle size, the small particles 12, and/or the medium particles 13 may have the same particle composition as in the large particles 11, or may have a particle composition different from the particle composition of the large particles 11. Note that, “different in a particle composition” represents a case where kinds of constituent elements contained in a particle main body are different from each other, or a case where content ratios of the constituent elements are different from each other even though kinds of the constituent elements match each other. The constituent elements represent elements contained in the particle main body in a ratio of 1 at % or more. That is, it is assumed that elements other than impurity elements among the elements contained in the particle main body are referred to as the constituent elements.

In a case where the small particles 12 and/or the medium particles 13 have a particle composition different from the particle composition of the large particles 11, the metal magnetic particles 10 may be classified by using composition analysis and particle size analysis in combination. Specifically, at the time of observing the cross-section of the magnetic core 2 by an electron microscope, the composition of each of the metal magnetic particles 10 included in an observation field of view is analyzed by using an energy dispersive X-ray analyzer (EDX device) or an electron probe microanalyzer (EPMA), and the metal magnetic particles 10 are classified on the basis of the composition. Then, a plurality of distribution curves are obtained by measuring the Heywood diameter of the metal magnetic particles 10 belonging to each composition.

For example, in a case where the metal magnetic particles 10 are constituted by four particle groups different in a particle composition, four distribution curves are obtained as shown in FIG. 2C. In the particle size distribution in FIG. 2C, a distribution curve of a particle group having Composition A is shown as a solid line, a distribution curve of a particle group having Composition B is shown as a dotted line, a distribution curve of a particle group having Composition C is shown as a one-dotted chain line, and a distribution curve of a particle group having Composition D is shown as a two-dotted chain line.

As shown in FIG. 2C, in a case where the particle size distributions of the metal magnetic particles 10 are expressed by a plurality of distribution curves corresponding to compositions, a particle group in which D20 is 3 μm or more is set as the large particles 11, a particle group in which D80 is less than 3 μm is set as the small particles 12, and particle groups other than the large particles 11 and the small particles 12 are set as the medium particles 13. That is, in FIG. 2C, the particle group having Composition A and the particle group having Composition B correspond to the large particles 11, the particle group having Composition C corresponds to the small particles 12, and the particle group having Composition D corresponds to the medium particles 13.

As described above, D20 of the large particles 11 is preferably 3 μm or more, and the Heywood diameter of the large particles 11 is preferably 3 μm or more in any particle. In addition, an average value (arithmetic average diameter) of the Heywood diameter of the large particles 11 is not particularly limited, and is preferably 5 to 40 μm, and more preferably 5 to 35 μm as an example. D80 of the small particles 12 is preferably less than 3 μm, and the Heywood diameter of the small particles 12 is preferably less than 3 μm in any particle. In addition, an average value (arithmetic average diameter) of the Heywood diameter of the small particles 12 is not particularly limited, and is preferably 2 μm or less, and more preferably 0.2 μm or more and less than 2 μm as an example.

When a total area ratio occupied by the large particles 11 on the cross-section of the magnetic core 2 is set as AL, and a total area ratio occupied by the small particles 12 on the cross-section of the magnetic core 2 is set as AS, AL is preferably larger than AS (AL>AS). Specifically, a ratio (AL/A0) of the total area of the large particles 11 to the total area of the metal magnetic particles 10 is preferably more than 50% and equal to or less than 90%, and more preferably 60% to 82%. In addition, a ratio (AS/A0) of the total area of the small particles 12 to the total area of the metal magnetic particles 10 is preferably 8% or more and less than 50%, and more preferably 10% to 40%. When the magnetic core 2 contains the small particles 12 at the above-described ratio in combination with the large particles 11, the magnetic permeability can be improved. Note that, AL and AS described above may be measured by a similar method as in A0.

In a case where the metal magnetic particles 10 include the medium particles 13, an average value (arithmetic average diameter) of the Heywood diameter of the medium particles 13 is not particularly limited, and is preferably 3 to 5 μm as an example. In addition, a ratio (AM/A0) of the total area of the medium particles 13 to the total area of the metal magnetic particles 10 is preferably 5% to 30%.

In addition, an average circularity of the large particles 11 on the cross-section of the magnetic core 2 is preferably 0.70 or more, and more preferably 0.90 or more. As the average circularity of the large particles 11 is higher, a withstand voltage and DC bias characteristics can be further improved. Note that, the circularity of the each of the large particles 11 is expressed by 2(πS_{L})^{1/2}/L when an area of each of the large particles 11 on the cross-section of the magnetic core 2 is set as S_{L}, and a peripheral length of the large particle 11 is set as L. The circularity of a perfect circle is 1, and a spheroidicity of a particle becomes higher as the circularity is closer to 1. An average circularity of the large particles 11 is preferably calculated by measuring the circularity of at least 100 large particles 11.

Note that, the average circularity of the small particles 12 and the average circularity of the medium particles 13 are not particularly limited, but the small particles 12 and the medium particles 13 preferably have a high average circularity as in the large particles 11. Specifically, any of the average circularity of the small particles 12 and the average circularity of the medium particles 13 is preferably 0.80 or more.

Note that, in this embodiment, the methods shown in FIGS. 2A to 2C are suggested as a method of classifying the metal magnetic particles 10 into the large particles 11, the small particles 12, and the like, but it is preferable to use the classification method shown in FIG. 2A or 2B in a case where the small particles 12 have the same particle composition as in the large particles 11, and it is preferable to use the classification method shown in FIG. 2C in a case where the small particles 12 have a particle composition different from the particle composition of the large particles 11.

In the magnetic core 2 of this embodiment, the large particles 11 include two or more kinds of particle groups different in a composition and an intragranular substance state. In other words, the large particles 11 can be subdivided into two or more kinds of particle groups on the basis of the composition and the intragranular substance state. Specifically, the large particles 11 include first large particles 11a formed from a crystalline metal magnetic material, and second large particles 11b having an amorphous structure or a nanocrystal structure. Description in which the second large particles 11b “have an amorphous structure or a nanocrystal structure” represents that a case where only one kind between large particles having the amorphous structure and large particles having the nanocrystal structure is present and a case where both the large particles having the amorphous structure and the large particles having the nanocrystal structure are mixed may exist. That is, the large particles 11 can be subdivided into three patterns to be described below.
Pattern A: A case where the first large particles 11a formed from the crystalline metal magnetic material and the second large particles 11b having the amorphous structure are mixed as the large particles 11
Pattern B: A case where the first large particles 11a formed from the crystalline metal magnetic material and the second large particles 11b having the nanocrystal structure are mixed as the large particles 11
Pattern C: A case where the first large particles 11a formed from the crystalline metal magnetic material, large particles (the second large particles 11b) having the amorphous structure, and large particles (the second large particles 11b) having the nanocrystal structure are mixed as the large particles 11

Here, the “amorphous structure” represents a substance state in which a long-range order as in a crystal hardly exists, and the degree of amorphization X is 85% or more. The amorphous structure includes a structure consisting of only an amorphous substance, and a structure consisting of hetero-amorphous substances. The structure consisting of the hetero amorphous substances represents a structure in which an initial fine crystal exists in the amorphous substance, and an average diameter of the initial fine crystal in the hetero amorphous structure is preferably 0.1 to 10 nm.

In addition, the “nanocrystal structure” represents a substance state in which the degree of amorphization X is less than 85%, and an average crystallite diameter is 0.5 to 30 nm. A maximum diameter of a crystallite in the nanocrystal structure is preferably 100 nm or less. On the other hand, the crystalline metal magnetic material has a crystalline structure different from the amorphous structure or the nanocrystal structure. “Crystalline structure” represents a substance state in which the degree of amorphization X is less than 85%, and the average crystallite diameter is 100 nm or more.

A substance state (that is, the degree of amorphization X or the crystallite size) of the large particles 11 can be specified by structure analysis using various electron microscopes such as a SEM, a TEM, and a STEM, electron beam diffraction, X-ray diffraction (XRD), electron backscattering diffraction (EBSD), or the like. For example, in an orientation mapping image of the EBSD, a bright field image of the electron microscope, and the like, a crystalline portion and an amorphous portion can be visually identified, and the degree of amorphization X and the average crystallite diameter can be measured by analyzing the images. In addition, in a case where spots caused by crystals are not confirmed in the electron beam diffraction, measurement target particles can be specified when the measurement target particles have an amorphous structure.

Note that, the degree of amorphization X (unit: %) is expressed by a relationship of X=(P_{A}/(P_{C}+P_{A}))×100 when a ratio of crystals is set as P_{C}, and a ratio of an amorphous substance is set as P_{A}. In a case of calculating the degree of amorphization X by using the XRD, the ratio P_{C} of the crystals may be measured as a crystalline scattering integrated intensity Ic, and the ratio P_{A} of the amorphous substance may be measured as an amorphous scattering integrated intensity Ia. In a case of calculating the degree of amorphization X by using the EBSD or the electron microscope, P_{C} may be measured as an area ratio of a crystal portion in a grain, and P_{A} may be measured as an area ratio of an amorphous portion.

In a case of classifying the large particles 11 by the electron microscope, as described above, structure analysis for specifying a substance state is performed on the large particles 11 included in an observation field of view, but the structure analysis may be performed by arbitrarily selecting some large particles 11 in the observation field of view. In this case, large particles 11 for which the substance state is specified may be regarded as analysis particles, and the other large particles 11 having the same composition as in the analysis particles may be regarded to have the same substance state as in the analysis particles.

For example, in a case where Fe—Si-based first large particles 11a and Fe—Co—B—P—Si—Cr-based second large particles 11b exist as the large particles 11, an Fe—Si-based particle group and an Fe—Co—B—P—Si—Cr-based particle group can be identified by area analysis using the EDX. Then, structure analysis is performed by selecting any analysis target particle from the Fe—Si-based particle group, and when it can be specified that the analysis target particle has a crystalline structure, any of the Fe—Si-based particle groups can be regarded to have the crystalline structure. Similarly, structure analysis is performed by selecting any analysis target particle from the Fe—Co—B—P—Si—Cr-based particle group, and when it can be specified that the analysis target particle has an amorphous structure, any of the Fe—Co—B—P—Si—Cr-based particle group can be regarded to have the amorphous structure.

A composition of the first large particles 11a having the crystalline structure is not particularly limited. Examples of a soft magnetic metal (crystalline metal magnetic material) having the crystalline structure include pure iron such as carbonyl iron, an Fe—Ni alloy, an Fe—Si-based alloy, an Fe—Si—Cr-based alloy, an Fe—Si—Al-based alloy, an Fe—Si—Al—Ni-based alloy, an Fe—Ni—Si—Co-based alloy, an Fe—Co-based alloy, an Fe—Co—V-based alloy, an Fe—Co—Si-based alloy, an Fe—Co—Si—Al-based alloy, and the like.

A composition of the second large particles 11b having an amorphous structure or a nanocrystal structure is not particularly limited. Examples of a soft magnetic alloy having the nanocrystal structure or a soft magnetic alloy having the amorphous structure include an Fe—Si—B-based alloy, an Fe—Si—B—C-based alloy, an Fe—Si—B—C—Cr-based alloy, an Fe—Nb—B-based alloy, an Fe—Nb—B—P-based alloy, an Fe—Nb—B—Si-based alloy, an Fe—Co—P—C-based alloy, an Fe—Co—B-based alloy, an Fe—Co—B—Si-based alloy, an Fe—Si—B—Nb—Cu-based alloy, an Fe—Si—B—Nb—P-based alloy, an Fe—Co—B—P—Si alloy, an Fe—Co—B—P—Si—Cr alloy, and the like.

A total area ratio occupied by the first large particles 11a having the crystalline structure on the cross-section of the magnetic core 2 is set as AL₁, and a ratio of the total area of the first large particles 11a to the total area of the metal magnetic particles 10 is expressed as AL₁/A0. Similarly, a total area ratio occupied by the second large particles 11b having the amorphous structure or the nanocrystal structure on the cross-section of the magnetic core 2 is set as AL₂, and a ratio of the total area of the second large particles 11b to the total area of the metal magnetic particles 10 is expressed as AL₂/A0. Any of AL₁/A0 and AL₂/A0 is preferably 0.5% or more, more preferably 0.5% to 99.5%, and still more preferably 0.5% to 90%.

In addition, the ratio of the total area of the first large particles 11a to the total area of the large particles 11 can be expressed as AL₁/AL, and the ratio of the total area of the second large particles 11b to the total area of the large particles 11 can be expressed as AL₂/AL. In a case where the large particles 11 are constituted by the first large particles 11a having the crystalline structure and the second large particles 11b having the amorphous structure (Pattern A), AL₁/AL and AL₂/AL are preferably 1% to 99%. From the viewpoint of lowering the core loss, AL₁/AL is more preferably 50% or less (that is, AL₁≤AL₂). Note that, in a case where the first large particles 11a having the crystalline structure and the second large particles 11b having the amorphous structure are mixed (Pattern A), DC bias characteristics tend to be further improved in comparison to a case where the first large particles 11a having the crystalline structure and the second large particles 11b having the nanocrystal structure are mixed (Pattern B).

In a case where the large particles 11 are constituted by the first large particles 11a having the crystalline structure and the second large particles 11b having the nanocrystal structure (Pattern B), AL₁/AL and AL₂/AL are preferably 1% to 99%. From the viewpoint of lowering the core loss, AL₁/AL is 50% or less (that is, AL₁≤AL₂), and from the viewpoints of obtaining more excellent DC bias characteristics, AL₁/AL is more preferably 50% or more (that is, AL₁≥AL₂). Note that, in a case where the first large particles 11a having the crystalline structure and the second large particles 11b having the nanocrystal structure are mixed (Pattern B), the core loss tends to be further lowered in comparison to the case where the first large particles 11a having the crystalline structure and the second large particles 11b having the amorphous structure are mixed (Pattern A).

In a case where the second large particles 11b having the amorphous structure and the second large particles 11b having the nanocrystal structure are mixed in combination with the first large particles 11a having the crystalline structure (Pattern C), a total area ratio occupied by the second large particles 11b having the amorphous structure on the cross-section of the magnetic core 2 is set as AL₂, and a total area ratio occupied by the second large particles 11b having the nanocrystal structure is set as AL₃ (AL₁+AL₂+AL₃=AL). In Pattern C in which three kinds of large particles are mixed, any of AL₁/AL, AL₂/AL, and AL₃/AL are also preferably within a range of 1% to 99%. From the viewpoint of lowering the core loss, it is preferable to satisfy a relationship of AL₁≤(AL₂+AL₃), and more preferably a relationship of AL₂≤AL₃. From the viewpoint of further improving the DC bias characteristics, it is preferable to satisfy a relationship of AL₂≥AL₃.

Note that, AL₁, AL₂, and AL₃ may be measured by the same method as in the total area ratio A0 of the metal magnetic particles 10.

In a case where the metal magnetic particles 10 include the small particles 12, a composition of the small particles 12 is not particularly limited. The small particles 12 may have the amorphous structure or the nanocrystal structure, but it is preferable to have the crystalline structure from the viewpoint of a saturation magnetic flux. Examples of a soft magnetic metal having the crystalline structure include pure iron such as carbonyl iron, Co, an Fe—Ni-based alloy, an Fe—Si-based alloy, an Fe—Si—Cr-based alloy, an Fe—Si—Al-based alloy, an Fe—Si—Al—Ni-based alloy, an Fe—Ni—Si—Co-based alloy, an Fe—Co-based alloy, an Fe—Co—V-based alloy, an Fe—Co—Si-based alloy, an Fe—Co—Si—Al-based alloy, a Co-based alloy, and the like. Particularly, the small particles 12 are preferably pure iron particles, Fe—Ni-based alloy particles, Fe—Co-based alloy particles, Fe—Si-based alloy particles, or Co particles.

In addition, in a case where the metal magnetic particles 10 include the medium particles 13, a composition of the medium particles 13 is not particularly limited. For example, the medium particles 13 may have the crystalline structure, but it is preferable to have the nanocrystal structure or the amorphous structure from the viewpoint of lowering coercivity.

Note that, the composition of the metal magnetic particles 10 can be analyzed, for example, by using an EDX device or an EPMA attached to an electron microscope. The first large particles 11a and the second large particles 11b can be distinguished by area analysis using the EDX device or the EPMA. In addition, the composition of the metal magnetic particles 10 may be analyzed by using a three-dimensional atom probe (3DAP). In a case of using the 3DAP, an average composition can be measured by setting a small region (for example, a region of Φ20 nm×100 nm) at the inside of the metal magnetic particles as a measurement target, a composition of a particle main body can be specified by excluding a resin component contained in the magnetic core 2, and an influence due to oxidation of a particle surface or the like.

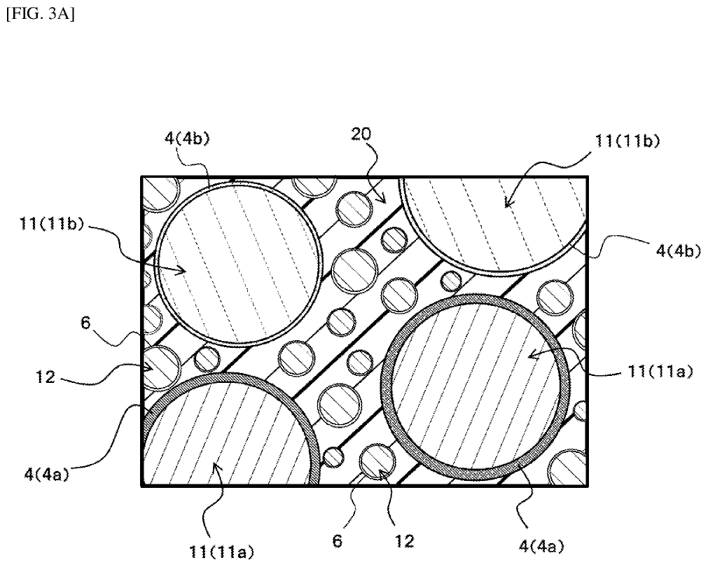

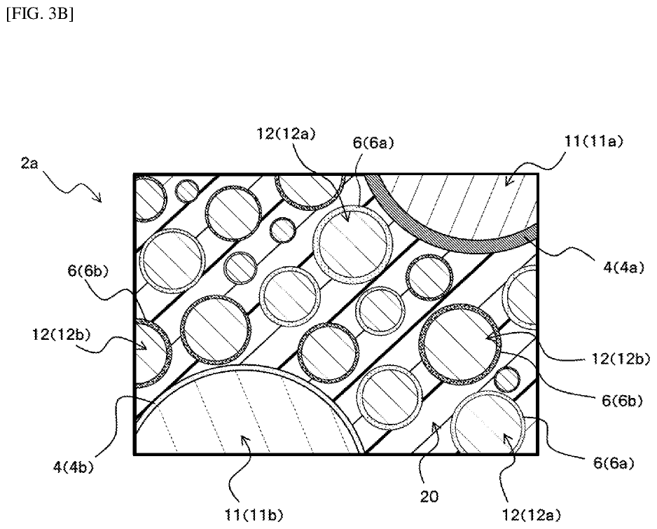

As shown in FIG. 3A, each of the first large particles 11a includes an insulation coating 4a that covers a particle surface, and each of the second large particles 11b includes an insulation coating 4b that covers a particle surface. Any of the insulation coating 4a and the insulation coating 4b may cover the entirety of the particle surface, or may cover only a part of the particle surface. Each of the insulation coating 4a and the insulation coating 4b preferably covers 80% or more of the particle surface observed on the cross-section of the magnetic core 2.

In addition, any of the insulation coating 4a and the insulation coating 4b may have a deviation in a thickness or a variation in the thickness in a single particle, but it is preferable to have a uniform thickness as can as possible. For example, an arithmetic average height Ra in a contour curve of a coating surface is preferably 0.5 to 100 nm. Ra is a kind of a line roughness parameter. An outermost surface portion of the insulation coating (4a or 4b) observed on the cross-section of the magnetic core 2 may be specified as the contour curve, and Ra may be calculated in conformity to a method defined in JIS standard B601.

A material of the insulation coating 4a and a material of the insulation coating 4b are not particularly limited, and the insulation coating 4a and the insulation coating 4b may have the same composition or may be compositions different from each other. For example, the insulation coating 4a and the insulation coating 4b may include a coating due to oxidation of the particle surface, and/or a coating containing an inorganic material such as BN, SiO₂, MgO, Al₂O₃, phosphate, silicate, borosilicate, bismuthate, and various kinds of glass.

From the viewpoint of suppressing a decrease in resistivity of the magnetic core 2, any of the insulation coating 4a and the insulation coating 4b preferably includes an oxide glass coating containing one or more kinds of elements selected among P, Si, Bi, and Zn. In the oxide glass coating, when a total amount of elements excluding oxygen among elements contained in the coating is set to 100 wt %, it is preferable that the total amount of one or more kinds of elements selected among P, Si, Bi, and Zn is the greatest, and more preferably 50 wt % or more, and still more preferably 60 wt % or more.

Examples of the oxide glass coating include a phosphate (P₂O₅)-based glass coating, a bismuthate (Bi₂O₃)-based glass coating, a borosilicate (B₂O₃—SiO₂)-based glass coating, and the like. Examples of the phosphate-based glass include P—Zn—Al—O-based glass, P—Zn—Al—R—O-based glass (“R” is one or more kinds of elements selected from alkali metals), and the like, and 50 wt % or more of P₂O₅ is preferably contained in the phosphate-based glass. Examples of the bismuthate-based glass include Bi—Zn—B—Si—O-based glass, Bi—Zn—B—Si—Al—O-based glass, and the like, and 50 wt % or more of Bi₂O₃ is preferably contained in the bismuthate-based glass coating. Examples of the borosilicate-based glass include Ba—Zn—B—Si—Al—O-based glass, and the like, and 10 wt % or more of B₂O₃ is preferably contained in the borosilicate-based glass coating.

Note that, in a case where three kinds of large particles are mixed (that is, as the second large particles 11b, large particles having the amorphous structure and large particles having the nanocrystal structure are mixed), the insulation coating 4b provided in the second large particles 11b having the amorphous structure, and the insulation coating 4b provided in the second large particles 11b having the nanocrystal structure may have the same composition, or may have compositions different from each other.

In addition, any of the insulation coating 4a and the insulation coating 4b may have a single-layer structure or may have a multi-layer structure. Examples of the multilayer structure include a stacked structure including an oxide layer of a particle surface and an oxide glass layer that covers the oxide layer. In a case where the insulation coating (4a and/or 4b) has the multilayer structure, a total thickness of respective layers is set as the thickness of the insulation coating. In addition, a composition of the insulation coating 4a and the insulation coating 4b can be analyzed, for example, by the EDX, the EPMA, or electron energy loss spectroscopy (EELS).

In the magnetic core 2 of this embodiment, the insulation coating 4a of the first large particles 11a is thicker than the insulation coating 4b of the second large particles 11b. When the first large particles 11a having the crystalline structure includes an insulation coating thicker than an insulation coating of the second large particles 11b having the amorphous structure or the nanocrystal structure (in other words, when the second large particle 11b having the amorphous structure or the nanocrystal structure includes the insulation coating thinner than the insulation coating of the first large particles 11a having the crystalline structure), the core loss characteristics and the DC bias characteristics can be improved in a compatible manner.

When an average thickness of the insulation coating 4a of the first large particles 11a is set as T1, and an average thickness of the insulation coating 4b of the second large particles 11b is set as T2, T1/T2 is more than 1.0, preferably 1.3 or more, more preferably 1.3 to 50, and still more preferably 1.3 to 20. In addition, T1 is preferably 200 nm or less, and T2 is preferably 5 to 50 nm.

Note that, in a case of Pattern C in which three kinds of large particles are mixed, an average thickness of the insulation coating 4b in the second large particles 11b having the amorphous structure is set as T2, and an average thickness of the insulation coating 4b in the second large particles 11b having the nanocrystal structured is set as T3. Even in Pattern C, T1 is thicker than T2 (T1>T2), and T1 is thicker than T3 (T1>T3). T1/T3 may be set within the same range as in T1/T2, and T3 is preferably 5 to 50 nm. A relationship between T2 and T3 is not particularly limited, T2 and T3 may be similar to each other, and T2 and T3 may be different from each other.

T1 may be calculated by observing the cross-section of the magnetic core 2 with various electron microscopes, and it is preferable to calculate T1 by measuring the thickness of the insulation coating 4a with respect to at least 10 first large particles 11a. T2 (and T3) may be calculated by a similar method as in T1.

Note that, large particles 11 which do not include the insulation coating 4 may be contained in the magnetic core 2.

In a case where the metal magnetic particles 10 include the small particles 12, the small particles 12 may not include an insulation coating, but each of the small particles 12 preferably includes an insulation coating 6 that covers a particle surface. A material of the insulation coating 6 is not particularly limited, for example, the insulation coating 6 may be a coating (oxide coating) due to oxidation of a surface of the small particle 12, or a coating containing an inorganic material such as BN, SiO₂, MgO, Al₂O₃, phosphate, silicate, borosilicate, bismuthate, and various kinds of glass, and it is preferable to include an oxide glass coating. In addition, the insulation coating 6 may have a single-layer structure, or may have a structure in which two or more coatings are stacked. An average thickness of the insulation coating 6 is not particularly limited, and for example, the average thickness is preferably 5 to 200 nm, and more preferably 5 to 100 nm.

In a case where the metal magnetic particles 10 include the medium particles 13, the medium particles 13 preferably include an insulation coating that covers a particle surface in a similar manner as in the other particle groups. A composition of the insulation coating of the medium particles 13 is not particularly limited, and may have the same composition as in the insulation coating (4a or 4b) of the large particles 11, or may have a composition different from the composition of the insulation coating (4a or 4b) of the large particles 11. An average thickness of the insulation coating of the medium particles 13 is not particularly limited, and for example, the average thickness is preferably 5 to 200 nm, and more preferably 10 to 100 nm.

The insulation coating 6 of the small particles 12 and the insulation coating of the medium particles 13 may cover the entirety of the particle surface as in the insulation coating 4 or may cover only a part of the particle surface. Each of the insulation coatings preferably covers 80% or more of the particle surface observed on the cross-section of the magnetic core 2. Note that, the small particles 12 or the medium particles 13 which do not include the insulation coating may be contained in the magnetic core 2.

The resin 20 functions an insulating binder that fixes the metal magnetic particles 10 in a predetermined dispersed state. A material of the resin 20 is not particularly limited, and the resin 20 preferably includes a thermosetting resin such as an epoxy resin.

Note that, the magnetic core 2 may contain a modifier for suppressing contact between soft magnetic metal particles. As the modifier, polymer materials such as polyethylene glycol (PEG), polypropylene glycol (PPG), and polycaprolactone (PCL) can be used, and polymeric materials having a polycaprolactone structure are preferably used. Examples of a polymer having the polycaprolactone structure include raw materials of urethane such as polycaprolactone diol and polycaprolactone tetraol, and part of polyesters. The content of the modifier is preferably 0.025 to 0.500 wt % with respect to the total amount of the magnetic core 2. It is considered that the modifier exists in a state of being absorbed to coat the surface of the metal magnetic particles 10.

Hereinafter, an example of a method of manufacturing the magnetic core 2 according to this embodiment is described.

First, a raw material powder including the first large particles 11a and a raw material powder including the second large particles 11b are manufactured as a raw material powder of the metal magnetic particles 10. In addition, in a case of adding the small particles 12 or the medium particles 13 to the magnetic core 2, a raw material powder including the small particles 12 and a raw material powder including the medium particles 13 are prepared. A method of manufacturing each of the raw material powders is not particularly limited, and an appropriate manufacturing method may be used in corresponding to a desired particle composition. For example, the raw material powders may be prepared by an atomization method such as a water atomization method and a gas atomization method. Alternatively, the raw material powders may be prepared by a synthesis method such as a CVD method using at least one or more kinds among evaporation, reduction, and thermal decomposition of metal salts. In addition, the raw material powders may be prepared by using an electrolytic method or a carbonyl method, or may be prepared by pulverizing starting alloys having a ribbon shape or a thin plate. Particularly, a raw material powder including the second large particles 11b having the amorphous structure or the nanocrystal structure is preferably manufactured by a rapid-cooling gas atomization method.

A particle size of each of the raw material powders can be adjusted by manufacturing conditions of the powders or various classification methods. In addition, in a case where the second large particles 11b are set to have the nanocrystal structure, a heat treatment for controlling a crystal structure is preferably performed on the raw material powders.

Note that, in a case where the small particles 12 is set to have the same composition as in the large particles 11 (the first large particles 11a or the second large particles 11b), a raw material powder having a wide particle size distribution may be manufactured, and the raw material powder may be classified to obtain a raw material powder including the large particles 11 and a raw material powder including the small particles 12.

Next, a coating forming treatment is performed on each of the raw material powder. In a case of manufacturing the magnetic core by using metal magnetic powders including a plurality of particle groups, typically, a plurality of raw material powders are mixed and then the coating forming treatment is performed at a time on the mixed powder to simplify a manufacturing process. However, when performing the coating forming treatment on the mixed powder, insulation coatings of respective particle groups have a similar thickness (that is, T1≈T2). In this embodiment, in order to make the insulation coating 4a of the first large particles 11a thicker than the insulation coating 4b of the second large particles 11b (that is, to realize a relationship of T1>T2), the coating forming treatment is individually performed on the first large particles 11a and the second large particles 11b.

Examples of a coating forming treatment method include a heat treatment, a phosphate treatment, mechanical alloying, a silane coupling treatment, hydrothermal synthesis, and the like, and an appropriate coating forming treatment may be selected in correspondence with the kind of the insulation coating to be formed.

For example, in a case where the insulation coating 4a and/or the insulation coating 4b include the oxide glass coating, the oxide glass coating is preferably formed by a mechano-chemical method using a mechano-fusion device. Specifically, in a coating forming treatment by the mechano-chemical method, a raw material powder including large particles, and a powder-shaped coating material including a constituent element of an insulation coating are introduced into a rotary rotor of the mechano-fusion device, and the rotary rotor is caused to rotate. A press head is provided inside the rotary rotor, and when the rotary rotor is caused to rotate, a mixture of the raw material powder and the coating material is compressed in a gap between an inner wall surface of the rotary rotor and the press head, and friction heat occurs. Due to the friction heat, the coating material is softened, and is fixed to a surface of the large particles due to a compression operation, and the oxide glass coating is formed.

Note that, the thickness of the insulation coating 4a and the thickness of the insulation coating 4b may be controlled on the basis of a mixing ratio of the coating material, a rotation speed, treatment time, and the like. In addition, in a case where large particles having the amorphous structure and large particles having the nanocrystal structure are mixed, a raw material powder having the amorphous structure and a raw material powder having the nanocrystal structure are mixed as the second large particles 11b, and the coating forming treatment may be performed on the resultant mixed powder. In this case, the insulation coating 4b of the amorphous second large particles 11b and the insulation coating 4b of nanocrystalline second large particles have a similar thickness (T2≈T3).

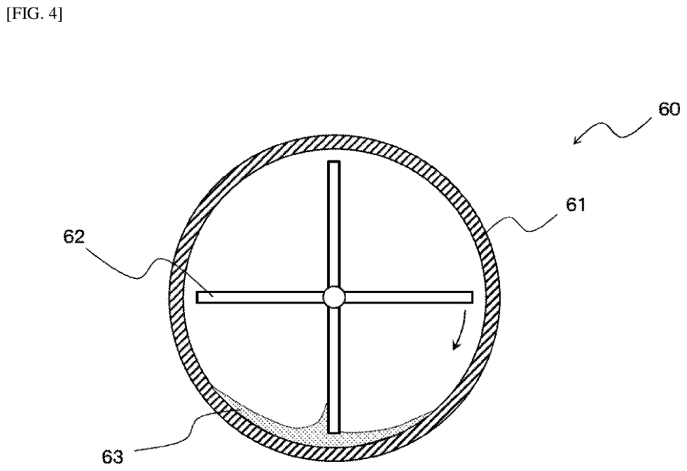

In a case of forming the insulation coating 6 with respect to the small particles 12, it is preferable to form the insulation coating 6 by mixing a raw material powder including the small particles 12 and a powder-shaped coating material including a constituent element of the insulation coating 6 while applying mechanical impact energy to the resultant mixture, and it is more preferable to form the insulation coating 6 by mixing the raw material powder and the coating material while applying impact, compression, and shear energy to the resultant mixture. In the coating forming treatment, as a device capable of applying mechanical energy to a powder, a powder treatment device such as a planetary ball mill and Nobilta manufactured by HOSOKAWA MICRON CORPORATION can be used. For example, in a coating forming treatment performed on the small particles 12, a powder treatment device 60 capable of performing mixing at a high rotation speed as shown in FIG. 4 can be used.

The powder treatment device 60 has a cylindrical cross-section and includes a chamber 61 in which a rotatable blade 62 is provided inside the chamber 61. A raw material powder including the small particles 12 and a coating material are put into the chamber 61, and the blade 62 is caused to rotate at a rotational speed of 2000 to 6000 rpm, thereby applying mechanical impact, compression, and shear energy to a mixture 63 of the raw material powder and the coating material. When using the powder treatment device 60, even in the small particles 12 having a small particle size, the insulation coating 6 can be formed on the particle surface.

In a case of using the medium particles 13 including an insulation coating, the medium particles 13 may be mixed with the first large particles 11a or the second large particles 11b and may be subjected to the coating forming treatment in combination with the first large particles 11a or the second large particles 11b to form the insulation coating on surfaces of the medium particles 13. Alternatively, the coating forming treatment may be individually performed on only the raw material of the medium particles 13.

Hereinafter, a method of manufacturing the magnetic core 2 by using respective raw material powders of the metal magnetic particle 10 is described. First, respective raw material powders on which the insulation coating is formed and a resin raw material (thermosetting resin or the like) are kneaded to obtain a resin compound. In the kneading process, various kneaders such as a kneader, a planetary mixer, a rotation/revolution mixer, and a twin-screw extruder may be used, and a modifier, a preservative, a dispersant, a non-magnetic powder, or the like may be added to the resin compound.

Next, the resin compound is filled in a press mold and compression molding is performed to obtain a green compact. A molding pressure at this time is not particularly limited, and is preferably set to, for example, 50 to 1200 MPa. Note that, a total area ratio of the metal magnetic particles 10 in the magnetic core 2 can be controlled by an addition amount of the resin 20, but can also be controlled by the molding pressure. In a case of using the thermosetting resin as the resin 20, the green compact is maintained at 100° C. to 200° C. for 1 to 5 hours to harden the thermosetting resin. The magnetic core 2 shown in FIG. 1 is obtained by the above-described processes.

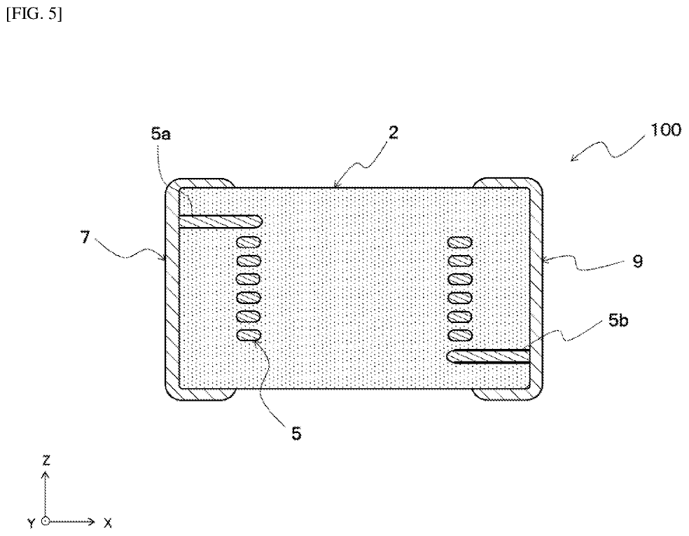

The magnetic core 2 according to this embodiment is applicable to various magnetic components such as an inductor, a transformer, and a choke coil. For example, a magnetic component 100 shown in FIG. 5 is an example of a magnetic component including the magnetic core 2.

In the magnetic component 100 shown in FIG. 5, an element body is constituted by the magnetic core 2 shown in FIG. 1. A coil 5 is embedded inside the magnetic core 2 that is the element body, and end portions 5a and 5b of the coil 5 are respectively drawn to end surfaces of the magnetic core 2. In addition, a pair of external electrodes 7 and 9 are respectively formed on the end surfaces of the magnetic core 2, and the pair of external electrodes 7 and 9 are respectively electrically connected to the end portions 5a and 5b of the coil 5. Note that, in a case where the coil 5 is embedded inside the magnetic core 2 as in the magnetic component 100, it is assumed that the area ratios of the metal magnetic particles 10 such as A0, A1, A2, AL, and AS are analyzed in fields of view where the coil 5 does not come into sight.

An application of the magnetic component 100 shown in FIG. 5 is not particularly limited, but the magnetic component 100 is suitable, for example, for a power inductor that is used in a power supply circuit, and the like. Note that, the magnetic component including the magnetic core 2 is not limited to an aspect as shown in FIG. 5, and may be a magnetic component obtained by winding a wire around the surface of the magnetic core 2 having a predetermined shape in a predetermined number of turns.

(Summary of First Embodiment)

The magnetic core 2 of this embodiment contains the metal magnetic particles 10 and the resin 20, and the total area ratio A0 of the metal magnetic particles 10 appear on the cross-section of the magnetic core 2 is 75% to 90%. The metal magnetic particles 10 include the first large particles 11a having the crystalline structure, and the second large particles 11b having the amorphous structure or the nanocrystal structure, and the insulation coating 4a of the first large particles 11a is thicker than the insulation coating 4b of the second large particles 11b.

Since the magnetic core 2 has the above-described characteristics, the core loss characteristics and the DC bias characteristics can be improved in a compatible manner. Specifically, the following facts have been clarified by experiments conducted by inventors of the present disclosure.

As the soft magnetic metals, a crystalline soft magnetic metal, an amorphous soft magnetic metal, and a nanocrystalline soft magnetic metal are known. In the crystalline soft magnetic metal, a saturation magnetic flux density is higher and the core loss is also higher in comparison to the other kinds, but the core loss tends to decrease in accordance with an increase in a packing rate of the crystalline soft magnetic metal (particles) in the magnetic core. On the other hand, in the nanocrystalline soft magnetic metal, the saturation magnetic flux density is lower in comparison to the other kinds, and the core loss tends to increase in accordance with an increase in a packing rate of the nanocrystalline soft magnetic metal (particles) in the magnetic core. The amorphous soft magnetic metal has characteristics between the crystalline soft magnetic metal and the nanocrystalline soft magnetic metal, and the core loss tends to increase in accordance with an increase in a packing rate of the amorphous soft magnetic metal (particles) in the magnetic core.

In addition, the crystalline soft magnetic metal has lower Vickers hardness in comparison to the other kinds, and is likely to be plastically deformed. Therefore, in a case of using the crystalline soft magnetic metal particles as a main powder of the magnetic core, when manufacturing a magnetic core at a high molding pressure, it is possible to increase the packing rate of the soft magnetic metal particles in comparison to a case of using the other kinds of soft magnetic metal particles. However, in a case of providing a coil inside the magnetic core, when raising the molding pressure, there is a concern that the coil is deformed, and the performance of the coil component deteriorates. Therefore, it is preferable that the magnetic core is manufactured at a molding pressure as low as possible. However, when the molding pressure is low, plastic deformation of the crystalline soft magnetic metal particles does not uniformly occur, and local plastic deformation thereof occurs inside the magnetic core, and thus local magnetic saturation occurs, and the DC bias characteristics deteriorate.

In the magnetic core 2 of this embodiment, the first large particles 11a which include the relatively thick insulation coating 4a and have the crystalline structure, and the second large particles 11b which include the relatively thin insulation coating 4b and have the amorphous structure or the nanocrystal structure are mixed, and thus even when being manufactured at a relatively low molding pressure (for example, 98 MPa to 490 MPa), occurrence of the local magnetic saturation can be suppressed. As a result, in the magnetic core 2 of this embodiment, the low core loss and the excellent DC bias characteristics are compatible with each other.

The ratio (T1/T2) of the average thickness T1 of the insulation coating 4a of the first large particles 11a to the average thickness T2 of the insulation coating 4b of the second large particles 11b is preferably 1.3 to 50, and more preferably 1.3 to 20. When T1/T2 is set to the above-described range, the low core loss and the excellent DC bias characteristics can be made to be more appropriately compatible with each other.

In addition, the average thickness T2 of the insulation coating 4b of the second large particles 11b is preferably 5 to 50 nm. When T2 is set to the above-described range, the core loss can be further reduced while securing high magnetic permeability.

### Second Embodiment

In a second embodiment, a magnetic core 2a shown in FIG. 3B is described. Note that, in the second embodiment, description of a configuration common to the first embodiment is omitted, and the same reference number as in the first embodiment is used.

As shown in FIG. 3B, in the magnetic core 2a of the second embodiment, the first large particles 11a having the crystalline structure, and the second large particles 11b having the amorphous structure or the nanocrystal structure are mixed, and the insulation coating 4a of the first large particles 11a is thicker than the insulation coating 4b of the second large particles 11b. Accordingly, even in the magnetic core 2a of the second embodiment, a similar operational effect as in the magnetic core 2 of the first embodiment is obtained.

Two or more kinds of small particles 12 different in a composition of the insulation coating 6 are contained in the magnetic core 2a. In other words, the small particles 12 included in the metal magnetic particles 10 can be subdivided into two or more kinds of small particle groups on the basis of a coating composition. Specifically, the small particles 12 include at least first small particles 12a including a first insulation coating 6a and second small particles 12b including a second insulation coating 6b having a composition different from a composition of the first insulation coating 6a, and may further include third small particles 12c to n^{th} small particles 12x having a coating composition different from that of the other small particle groups. n represents the number of small particle groups in a case of subdividing the small particles 12 on the basis of the coating composition, and an upper limit of n is not particularly limited. From the viewpoint of simplifying manufacturing processes, n is preferably 4 or less.

Here, “different in a coating composition” represents that the kinds of constituent elements contained in the insulation coating 6 are different from each other, and the constituent elements of the insulation coating 6 represent elements contained in the insulation coating 6 by 1 at % or more when a total content ratio of elements other than oxygen and carbon among elements contained in the insulation coating 6 is set to 100 at %. The composition of the insulation coating 6 may be analyzed by area analysis or point analysis using the EDX device or the EPMA.

A material of the insulation coatings 6 (the first insulation coating 6a, the second insulation coating 6b, and the third insulation coating 6c to the n^{th} insulation coating 6x) included in the small particles 12 is not particularly limited. For example, each of the insulation coatings 6 may be set as a coating (oxide coating) due to oxidation of surfaces of the small particles 12, or a coating containing an inorganic material such as BN, SiO₂, MgO, Al₂O₃, phosphate, silicate, borosilicate, bismuthate, and various kinds of glass. It is preferable that the insulation coating 6 includes an oxide glass coating. Examples of the oxide glass include silicate (SiO₂)-based glass, phosphate (P₂O₅)-based glass, bismuthate (Bi₂O₃)-based glass, borosilicate (B₂O₃—SiO₂)-based glass, and the like.

The first insulation coating 6a and the second insulation coating 6b may have compositions different from each other, and a combination of coating compositions is not particularly limited. For example, as a combination of the first insulation coating 6a and the second insulation coating 6b, a combination of a P—O-based glass coating and a P—Zn—Al—O-based glass coating, a combination of a Bi—Zn—B—Si—O-based glass coating and an Si—O-based glass coating, or a combination of a Ba—Zn—B—Si—Al—O-based glass coating and an Si—O-based glass coating is preferable, and the combination of the Ba—Zn—B—Si—Al—O-based glass coating and the Si—O-based glass coating is more preferable. Even in a case where the small particles 12 include the third small particles 12c to the n^{th} small particles 12x in addition to the first small particles 12a and the second small particles 12b, the combination of the coating compositions is not particularly limited, and the small particles 12 include the third small particles 12c to the n^{th} small particles 12x preferably include the oxide glass coating having a composition different from compositions of the other small particle groups.

The average thickness of the insulation coating 6 is not particularly limited, and for example, the average thickness is preferably 5 to 200 nm, and more preferably 5 to 100 nm. The first insulation coating 6a to the n^{th} insulation coating 6x may have a similar average thickness or may have average thicknesses different from each other.

Note that, the insulation coating 6 such as the first insulation coating 6a and the second insulation coating 6b may have a stacked structure in which a plurality of coating layers are stacked. For example, the insulation coating 6 may have a stacked structure including an oxide layer of a particle surface, and an oxide glass layer that covers the oxide layer. In a case where one or more kinds of the insulation coatings 6 among the first insulation coating 6a to the n^{th} insulation coating 6x has the stacked structure, a composition of an outermost layer (a coating layer located on the most surface side) may be different among the first insulation coating 6a to the n^{th} insulation coating 6x, and compositions of the other coating layers located between the outermost layer and the particle surface may match each other or may be different from each other among the first insulation coating 6a to the n^{th} insulation coating 6x.

In addition, any of the first small particles 12a to the n^{th} small particles 12x may have the same particle composition or may have particle compositions different from each other. A substance state of the first small particles 12a to the n^{th} small particles 12x is not particularly limited, and one or more kinds of small particle groups among the first small particles 12a to the n^{th} small particles 12x may be amorphous or nanocrystals, but as described above, any of the first small particles 12a to the n^{th} small particles 12x is preferably crystalline.

Total area ratios occupied by the first small particles 12a to the n^{th} small particles 12x on the cross-section of the magnetic core 2a are set as AS₁ to ASₙ. In this case, a total area ratio AS occupied by the small particles 12 on the cross-section of the magnetic core 2a can be expressed as the sum of AS₁ to ASₙ. In addition, ratios of the total area ratios of respective small particle groups to the total area ratio AS of the small particles 12 can be expressed as AS₁/AS to ASₙ/AS. Any of AS₁/AS to ASₙ/AS is preferably 1% or more, more preferably 6% or more, and still more preferably 10% or more.

When manufacturing the magnetic core 2a, the coating forming treatment is individually formed on each of the small particle groups (first small particles 12a to the n^{th} small particles 12x), and in the coating forming treatment on each of the small particle groups, the powder treatment device 60 as shown in FIG. 4 is preferably used as described in the first embodiment. In addition, the composition of the respective insulation coatings 6 (the first insulation coating 6a, the second insulation coating 6b, and the third insulation coating 6c to the n^{th} insulation coating 6x) may be controlled by a kind or a composition of a coating material that is mixed with a raw material powder. Note that, manufacturing conditions except for the above-described conditions may be set to be similar as in the first embodiment.

(Summary of Second Embodiment)

In the magnetic core 2a of the second embodiment, the second particle group 10b in which the Heywood diameter is less than 3 μm includes two or more kinds of small particles 12 (the first small particles 12a, the second small particles 12b, and the like) different in a coating composition.

As described above, when the metal magnetic particles 10 include two or more kinds of small particles 12 different in a coating composition, it is considered that when being kneaded with a resin, an electrical repulsive force between the metal magnetic particles is improved, and magnetic aggregation of the metal magnetic particles 10 is suppressed. As a result, in the magnetic core 2a, the DC bias characteristics can be further improved.

Hereinbefore, the embodiments of the present disclosure have been described, but the present disclosure is not limited to the above-described embodiments, and various modifications can be made within a range not departing from the gist of the present disclosure.

For example, the structure of the magnetic component is not limited to the aspect shown in FIG. 5, and a magnetic component may be manufactured by combining a plurality of the magnetic cores 2. In addition, the method of manufacturing the magnetic core is not limited to the manufacturing method illustrated in the above-described embodiments, and the magnetic core 2 and the magnetic core 2a may be manufactured by a sheet method or injection molding, or may be manufactured by two-stage compression. In the manufacturing method using the two-stage compression, for example, a plurality of preliminary molded bodies are prepared by temporarily compressing a resin compound, and the preliminary molded bodies are combined and subjected to main compression to obtain a magnetic core.

### EXAMPLES

Hereinafter, the present disclosure is described in more detail with reference to specific examples. However, the present disclosure is not limited to the following examples.

### Experiment 1

In Experiment 1, crystalline magnetic core samples (Sample A1 to Sample A6), amorphous magnetic core samples (Sample A7 to Sample A12), and nanocrystalline magnetic core samples (Sample A13 to Sample A18) were manufactured by using a metal magnetic powder obtained by mixing one kind of large particles and one kind of small particles. Note that, the magnetic cores of Samples A1 to A18 illustrated in Experiment 1 correspond to comparative examples of the present disclosure.

First, as a raw material powder of the metal magnetic particles, a large-diameter powder having the crystalline structure, a large-diameter powder having the amorphous structure, a large-diameter powder having the nanocrystal structure, and a small-diameter powder composed of pure iron small particles were prepared. The large-diameter powder having the crystalline structure is an Fe—Si-based alloy powder manufactured by a gas atomization method, an average particle size of the Fe—Si-based alloy powder was 20 μm, the degree of amorphization was less than 85%, and an average crystallite diameter was 100 nm or more. The large-diameter powder having the amorphous structure is an Fe—Co—B—P—Si—Cr-based alloy powder and was manufactured by a rapid-cooling gas atomization method. An average particle size of the Fe—Co—B—P—Si—Cr-based alloy powder was 20 μm, and the degree of amorphization was 85% or more. The large-diameter powder having the nanocrystal structure is an Fe—Si—B—Nb—Cu-based alloy powder, and was manufactured by performing a heat treatment on a powder obtained by the rapid-cooling gas atomization method. An average particle size of the Fe—Si—B—Nb—Cu-based alloy powder was 20 μm, the degree of amorphization was less than 85%, and an average crystallite diameter was within a range of 0.5 to 30 nm. In addition, an average particle size of the pure iron powder that is the small-diameter powder was 1 μm.

In Sample A1 to Sample A6 in Experiment 1, a coating forming treatment using a mechano-fusion device (AMS-Lab, manufactured by HOSOKAWA MICRON CORPORATION) was performed on the large-diameter powder having the crystalline structure to form an insulation coating of P—Zn—Al—O-based oxide glass on surfaces of large particles. In Sample A7 to Sample A12 in Experiment 1, the coating forming treatment using the mechano-fusion device was performed on the large-diameter powder having the amorphous structure to form an insulation coating of P—Zn—Al—O-based oxide glass on surfaces of large particles. In Sample A13 to Sample A18 in Experiment 1, the coating forming treatment using the mechano-fusion device was performed on the large-diameter powder having the nanocrystal structure to form an insulation coating of P—Zn—Al—O-based oxide glass on surfaces of large particles. Note that, in the coating forming treatment, an addition amount of the coating material was controlled so that an average thickness of the insulation coating becomes values shown in Table 1.

The coating forming treatment was performed on the small-diameter powder used in Experiment 1 by using the powder treatment device (Nobilta, manufactured by HOSOKAWA MICRON CORPORATION) as shown in FIG. 4 to form an insulation coating of Ba—Zn—B—Si—Al—O-based oxide glass on surfaces of small particles. An average thickness of the insulation coatings formed on the small particles was within a range of 15±10 nm in any sample.

Next, raw material powders (a large-diameter powder and a small-diameter powder) of the metal magnetic particles, and an epoxy resin were kneaded to obtain a resin compound. More specifically, in Sample A1 to Sample A6, large particles having the crystalline structure and small particles were mixed to obtain a resin compound. In Sample A7 to Sample A12, large particles having the amorphous structure and small particles were mixed to obtain a resin compound. In addition, in Sample A13 to Sample A18, large particles having the nanocrystal structure and small particles were mixed to obtain a resin compound. Note that, an addition amount of the epoxy resin (the amount of the resin) in the resin compound was set to 2.5 parts by mass with respect to 100 parts by mass of metal magnetic particles in any sample in Experiment 1. In addition, the large-diameter powder and the small-diameter powder were mixed so that an area ratio satisfies a relationship of “large particles:small particles=8:2” in any sample in Experiment 1.

Next, the resin compound was filled in a press mold and was pressurized to obtain a green compact having a toroidal shape. A molding pressure at this time was controlled so that magnetic permeability (μi) of the magnetic core becomes 30. Then, the green compact was subjected to a heating treatment at 180° C. for 60 minutes to harden the epoxy resin inside the green compact, thereby obtaining a magnetic core having a toroidal shape (an external shape of 11 mm, an inner diameter of 6.5 mm, and a thickness of 2.5 mm).

In the respective samples in Experiment 1, the following evaluation was made on the prepared magnetic cores.

Cross-Section Observation of Magnetic Core

A cross-section of each of the magnetic cores was observed with a SEM to calculate a ratio of a total area of the metal magnetic particles (the total area ratio A0 of the metal magnetic particles) to a total area (1000000 μm²) of an observation field of view. The total area ratio A0 of the metal magnetic particles was within a range of 80±2% in any of the respective samples in Experiment 1.

In addition, at the time of the SEM observation, the Heywood diameter of each of the metal magnetic particles was measured, and area analysis with the EDX was performed to specify a composition system of the metal magnetic particles, and the metal magnetic particles observed on the cross-section of the magnetic core were classified into large particles and small particles. In the respective samples in Experiment 1, D20 of the large particles was 3 μm or more, an average particle size (an arithmetic average value of the Heywood diameter) of the large particles was within a range of 10 to 30 μm, D80 of the small particles was less than 3 μm, and an average particle size of the small particles was within a range of 0.5 to 1.5 μm. In addition, a total area of the large particles included in the observation field of view and a total area of the small particles included in the observation field of view were measured, and a ratio (AL/A0) of the total area of the large particles to the total area of the metal magnetic particles, and a ratio (AS/A0) of the total area of the small particles to the total area of the metal magnetic particles were calculated.

In addition, in the SEM observation, the thickness of the insulation coating of each of the large particles existing in the observation field of view was measured, and an average thickness thereof was calculated.

Evaluation of Magnetic Permeability and DC bias Characteristics In evaluation of the magnetic permeability and the DC bias characteristics, first, a polyurethane copper wire (UEW wire) was wound around the magnetic core having a toroidal shape. Then, an inductance of the magnetic core at a frequency of 1 MHz was measured by using an LCR meter (4284A, manufactured by Agilent Technologies Japan, Ltd.) and a DC bias power supply (42841A, manufactured by Agilent Technologies Japan, Ltd.). More specifically, an inductance under a condition (0 kA/m) in which a DC magnetic field is not applied, and an inductance under a condition in which a DC magnetic field of 8 kA/m is applied were measured, and μi (magnetic permeability at 0 A/m) and μHdc (magnetic permeability at 8 kA/m) were calculated from the inductances.

The DC bias characteristics were evaluated on the basis of a variation rate of the magnetic permeability when applying the DC magnetic field. That is, the variation rate (unit: %) of the magnetic permeability is expressed as (μi−μHdc)/μi, and as the variation rate of the magnetic permeability is smaller, the DC bias characteristics can be determined as being good.

Evaluation of Core Loss

A core loss (unit: kW/m³) of each of the magnetic cores was measured by using a BH analyzer (SY-8218, manufactured by IWATSU ELECTRIC CO., LTD.). A magnetic flux density when measuring the core loss was set to 10 mT, and a frequency was set to 3 MHz.

Evaluation results of Experiment 1 are shown in Table 1.

TABLE 1

| | | Large particles | | | | | Mixing ratio of metal | | Magnetic | | |
|---|---|---|---|---|---|---|---|---|---|---|---|
| | Example/ | | | | Coating | | magnetic particles | | permeability | DC bias characteristics | |
| Sample | Comparative | | | | thickness | Composition | Large particles | Small particles | μi | (mi-mHdc)/mi | Core loss |
| No. | Example | Structure | Particle composition | Coating composition | (nm) | of small particles | AL/A0 (%) | AS/A0 (%) | (−) | (%) | (kW/m³) |
| A1 | Comparative | Crystalline | Fe—Si-based | P—Zn—Al—O-based | 5 | Fe | 79.0 | 21.0 | 30.5 | 20.1 | 2300 |
| | Example | | | | | | | | | | |
| A2 | Comparative | Crystalline | Fe—Si-based | P—Zn—Al—O-based | 15 | Fe | 79.3 | 20.7 | 30.3 | 20.1 | 2200 |
| | Example | | | | | | | | | | |
| A3 | Comparative | Crystalline | Fe—Si-based | P—Zn—Al—O-based | 50 | Fe | 79.1 | 20.9 | 30.4 | 15.4 | 2020 |
| | Example | | | | | | | | | | |
| A4 | Comparative | Crystalline | Fe—Si-based | P—Zn—Al—O-based | 100 | Fe | 78.6 | 21.4 | 30.2 | 13.3 | 1980 |
| | Example | | | | | | | | | | |
| A5 | Comparative | Crystalline | Fe—Si-based | P—Zn—Al—O-based | 150 | Fe | 79.5 | 20.5 | 30.3 | 12.1 | 1880 |
| | Example | | | | | | | | | | |
| A6 | Comparative | Crystalline | Fe—Si-based | P—Zn—Al—O-based | 200 | Fe | 81.2 | 18.8 | 30.4 | 10.2 | 1780 |
| | Example | | | | | | | | | | |
| A7 | Comparative | Amorphous | Fe—Co—B—P—Si—Cr-based | P—Zn—Al—O-based | 5 | Fe | 78.7 | 21.3 | 30.2 | 13.4 | 1200 |
| | Example | | | | | | | | | | |
| A8 | Comparative | Amorphous | Fe—Co—B—P—Si—Cr-based | P—Zn—Al—O-based | 15 | Fe | 80.8 | 19.2 | 30.8 | 13.5 | 1210 |
| | Example | | | | | | | | | | |
| A9 | Comparative | Amorphous | Fe—Co—B—P—Si—Cr-based | P—Zn—Al—O-based | 50 | Fe | 78.7 | 21.3 | 30.4 | 13.4 | 1250 |
| | Example | | | | | | | | | | |
| A10 | Comparative | Amorphous | Fe—Co—B—P—Si—Cr-based | P—Zn—Al—O-based | 100 | Fe | 80.8 | 19.2 | 30.5 | 13.6 | 1480 |
| | Example | | | | | | | | | | |
| A11 | Comparative | Amorphous | Fe—Co—B—P—Si—Cr-based | P—Zn—Al—O-based | 150 | Fe | 80.2 | 19.8 | 30.4 | 13.5 | 1510 |
| | Example | | | | | | | | | | |
| A12 | Comparative | Amorphous | Fe—Co—B—P—Si—Cr-based | P—Zn—Al—O-based | 200 | Fe | 79.9 | 20.1 | 30.1 | 13.6 | 1530 |
| | Example | | | | | | | | | | |
| A13 | Comparative | Nanocrystal | Fe—Si—B—Nb—Cu-based | P—Zn—Al—O-based | 5 | Fe | 79.6 | 20.4 | 30.7 | 19.4 | 560 |
| | Example | | | | | | | | | | |
| A14 | Comparative | Nanocrystal | Fe—Si—B—Nb—Cu-based | P—Zn—Al—O-based | 15 | Fe | 79.8 | 20.2 | 30.2 | 19.3 | 580 |
| | Example | | | | | | | | | | |
| A15 | Comparative | Nanocrystal | Fe—Si—B—Nb—Cu-based | P—Zn—Al—O-based | 50 | Fe | 79.7 | 20.3 | 30.2 | 19.5 | 590 |
| | Example | | | | | | | | | | |
| A16 | Comparative | Nanocrystal | Fe—Si—B—Nb—Cu-based | P—Zn—Al—O-based | 100 | Fe | 80.5 | 19.5 | 30.3 | 19.4 | 600 |
| | Example | | | | | | | | | | |
| A17 | Comparative | Nanocrystal | Fe—Si—B—Nb—Cu-based | P—Zn—Al—O-based | 150 | Fe | 80.2 | 19.8 | 30.1 | 19.4 | 610 |
| | Example | | | | | | | | | | |
| A18 | Comparative | Nanocrystal | Fe—Si—B—Nb—Cu-based | P—Zn—Al—O-based | 200 | Fe | 80.1 | 19.9 | 30.3 | 19.4 | 610 |
| | Example | | | | | | | | | | |

As shown in Table 1, in the magnetic cores of Sample A1 to Sample A6 in which crystalline large particles are set as a main powder (hereinafter, such magnetic core may be referred to as crystalline magnetic cores), as the insulation coating was made to be thicker, the DC bias characteristics and the core loss characteristic tended to be improved. However, even in Sample A6 in which the insulation coating is thickest, the core loss was higher in comparison to other Sample A7 to Sample A18. On the other hand, in the magnetic cores of Sample A7 to Sample A12 in which amorphous large particles are set as a main powder (hereinafter, such magnetic core may be referred to as amorphous magnetic cores), and the magnetic cores of Sample A13 to Sample A18 in which nanocrystalline large particles are set as a main powder (hereinafter, such magnetic core may be referred to as nanocrystalline magnetic cores), it could be understood that when the insulation coating is made to be thicker, the core loss tends to increase, and the DC bias characteristics hardy vary even when the insulation coating is made to be thicker.

In addition, the amorphous magnetic cores were more excellent in the DC bias characteristics in comparison to the crystalline magnetic cores and the nanocrystalline magnetic cores. The nanocrystalline magnetic cores had a tendency that the core loss was lower in comparison to the crystalline magnetic cores and the amorphous magnetic cores, but the DC bias characteristics was inferior. From the results, it could be understood that it is not easy to make a low core loss and good DC bias characteristics be compatible with each other in a case where the main powder of the magnetic cores is composed of only one kind of large particles.

### Experiment 2

In Experiment 2, 72 kinds of magnetic cores as shown in Table 2 and Table 3 were manufactured by using a metal magnetic powder obtained by mixing two kinds of large particles and small particles.

Even in Experiment 2, as the raw material powder of the metal magnetic particles, an Fe—Si-based alloy powder (crystalline first large particles), an Fe—Co—B—P—Si—Cr-based alloy powder (amorphous second large particles), an Fe—Si—B—Nb—Cu-based alloy powder (nanocrystalline second large particles), and a pure iron powder (small particles) were prepared. The respective raw material powders have the same specifications as in the raw material powders used in Experiment 1.

Next, an insulation coating of P—Zn—Al—O-based oxide glass was formed on surfaces of the particles of the Fe—Si-based alloy powder by using a mechano-fusion device. At this time, the thickness of the insulation coating was adjusted by controlling an addition amount of a coating material and treatment time, thereby obtaining six kinds of first large particles different in the average thickness T1. In addition, the coating forming treatment using the mechano-fusion device was performed on the Fe—Co—B—P—Si—Cr-based alloy powder to obtain six kinds of amorphous second large particles different in the average thickness T2. Similarly, the coating forming treatment using the mechano-fusion device was performed on the Fe—Si—B—Nb—Cu-based alloy powder, thereby obtaining six kinds of nanocrystalline second large particles different in the average thickness T2.

In addition, the coating forming treatment was performed on the pure iron powder by using the powder treatment device as shown in FIG. 4 to form an insulation coating of Ba—Zn—B—Si—Al—O-based oxide glass on surfaces of the small particles. An average thickness of the insulation coating of the small particles was within a range of 15±10 nm.

After performing the coating forming treatment on the respective raw material powders, in Sample B1 to Sample B36 in Table 2, the Fe—Si-based alloy powder composed of the crystalline first large particles, the Fe—Co—B—P—Si—Cr-based alloy powder composed of the amorphous second large particles, the pure iron powder composed of the small particles, and an epoxy resin were kneaded to obtain a resin compound. On the other hand, in Sample C1 to Sample C36 in Table 3, the Fe—Si-based alloy powder composed of the crystalline first large particles, the Fe—Si—B—Nb—Cu-based alloy powder composed of the nanocrystalline second large particles, the pure iron powder composed of the small particles, and the epoxy resin were kneaded to obtain a resin compound. At this time, the large particles and the small particles were mixed so that an area ratio satisfies a relationship of “first large particles:second large particles:small particles=4:4:2” in any sample in Experiment 2. In addition, an addition amount of the epoxy resin (the amount of the resin) in the resin compound was set to 2.5 parts by mass with respect to 100 parts by mass of metal magnetic particles in any sample in Experiment 2.

Next, the resin compound was filled in a press mold and was pressurized to obtain a green compact having a toroidal shape. A molding pressure at this time was controlled so that magnetic permeability (μi) of the magnetic core becomes 30. Then, the green compact was subjected to a heating treatment at 180° C. for 60 minutes to harden the epoxy resin inside the green compact, thereby obtaining a magnetic core having a toroidal shape (an external shape of 11 mm, an inner diameter of 6.5 mm, and a thickness of 2.5 mm).

Even in Experiment 2, similar evaluation as in Experiment 1 was performed. In cross-section observation of the magnetic core, in any sample, it was confirmed that D20 of the first large particles and the second large particles was 3 μm or more, an average particle size of the first large particles and the second large particles was within a range of 10 to 30 μm, D80 of the small particles was less than 3 μm, and an average particle size of the small particles was within a range of 0.5 to 1.5 μm. In addition, an average thickness T1 of the insulation coating provided in the first large particles, an average thickness T2 of the insulation coating provided in the second large particles having the amorphous structure or the nanocrystal structure, and ratios (AL₁/A0, AL₂/A0, AS/A0) of total areas of respective particle groups to a total area of the metal magnetic particles become results shown in Table 2 and Table 3. Note that, the total area ratio A0 of the metal magnetic particles was within a range of 80±2% in any of the samples in Experiment 2.

In Experiment 2, an expected value of the DC bias characteristics (a calculated value of the DC bias characteristics which is calculated from the mixing ratio) was calculated on the basis of the mixing ratio of the first large particles and the second large particles, and the quality of the DC bias characteristics in each sample was determined with the expected value set as a reference. For example, the expected value of the DC bias characteristics in Sample B1 was calculated by the following expression.

Expected value of DC bias characteristics=[(β₁/α₁)×C₁]+[(β₂/α₇)×C₇]
α₁: Ratio (AL/A0) of crystalline large particles in Sample A1
C₁: Variation rate of DC bias characteristics (a variation rate of magnetic permeability) of Sample A1
α₇: Ratio (AL/A0) of amorphous large particles in Sample A7
C₇: DC bias characteristics (a variation rate of magnetic permeability) of Sample A7
β₁: Ratio (AL₁/A0) of amorphous first large particles in Sample B1
β₂: Ratio (AL₂/A0) of amorphous second large particles in Sample B1

As described above, when calculating the expected value (unit: %) of the DC bias characteristics, characteristic values of the magnetic cores (Sample A1 to Sample A18) containing large particles having the same specifications (a particle composition, a coating composition, and an average thickness of a coating are the same) as in large particles used in the respective samples (Samples B1 to B36, and Sample C1 to Sample C36) were used with reference to Table 1.

After calculating the expected value of the DC bias characteristic by the above-described method, a difference between the expected value and actually measured DC bias characteristics (the expected value−the measured value) was calculated. As the “difference from the expected value” becomes larger than 0%, the variation rate ((μi−μHdc)/μi) of actually measured permeability is smaller, and the DC bias characteristics are further improved. In this experiment, DC bias characteristics of a sample in which the difference from the expected value is less than 5% were determined as “failed (F)”, and DC bias characteristics of a sample in which the difference from the expected value is 5% or more were determined as passing (G).

In addition, with regard to the core loss, in a similar manner as in the DC bias characteristics, an expected value of the core less on the basis of a mixing ratio of the first large particles and the second large particles (a calculated value of the core loss calculated from the mixing ratio), and the quality of the core loss in each sample was determined with the expected value set as a reference. For example, the expected value of the core loss in Sample B1 was calculated by the following expression.

Expected value of core loss=[(β₁/α₁)×δ₁]+[(β₂/α₇)×δ₇]
δ₁: Core loss of Sample A1
δ₇: Core loss of Sample A7

As described above, when calculating the expected value (unit: kW/m³) of the core loss, characteristic values of the magnetic cores (Sample A1 to Sample A18) containing large particles having the same specifications (a particle composition, a coating composition, and an average thickness of a coating are the same) as in large particles used in the respective samples (Samples B1 to B36, and Sample C1 to Sample C36) were used with reference to Table 1.

After calculating the expected value of the core loss by the above-described method, an improvement rate (unit: %) of the core loss was calculated from the expected value of the core loss and an actually measured core loss. An improvement rate of the core loss is expressed as “((expected value−measured value)/expected value)×100”, and as the improvement rate of the core loss is higher, the actually measured core loss is further reduced from the expected values calculated from a simple mixing ratio, and the core loss characteristics are further improved. In this experiment, a sample in which the improvement rate of the core loss is less than 5% was determined as “failed (F)”, a sample in which the improvement rate of the core loss is 5% or more and less than 10% was determined as “good (G)”, and a sample in which the improvement rate of the core loss is 10% or more was determined as “very good (VG)”.

Evaluation results of Experiment 2 are shown in Table 2 and Table 3.

TABLE 2

| | | First large particles | | Second large particles | | | Mixing ratio of metal magnetic particles | | | Magnetic | | | | Core loss | | |
|---|---|---|---|---|---|---|---|---|---|---|---|---|---|---|---|---|
| | Example/ | | Coating | | Coating | | First large | Second large | Small | permeability | DC bias characteristics | | | Measured | Improve- | |
| Sample | Comparative | Particle | thickness | Particle | thickness | | particles | particles | particles | μi | Measured | Difference from | Deter- | value | ment | Deter- |
| No. | Example | structure | T1 (nm) | structure | T2 (nm) | T1/T2 | AL₁/A0 (%) | AL₂/A0 (%) | AS/A0 (%) | (−) | value (%) | expected value | mination | (kW/m³) | rate (%) | mination |
| B1 | Comparative | Crystalline | 5 | Amorphous | 5 | 1.0 | 40.0 | 39.0 | 21.0 | 30.4 | 18.3% | −1.5% | F | 1780 | −1.2% | F |
| | Example | | | | | | | | | | | | | | | |
| B2 | Comparative | Crystalline | 5 | Amorphous | 15 | 0.3 | 39.6 | 40.3 | 20.1 | 30.0 | 18.4% | 1.6% | F | 1780 | −1.4% | F |
| | Example | | | | | | | | | | | | | | | |
| B3 | Comparative | Crystalline | 5 | Amorphous | 50 | 0.1 | 41.3 | 39.5 | 19.2 | 30.3 | 17.1% | 0.1% | F | 1820 | 0.6% | F |
| | Example | | | | | | | | | | | | | | | |
| B4 | Comparative | Crystalline | 5 | Amorphous | 100 | 0.1 | 39.0 | 39.2 | 21.8 | 30.3 | 16.4% | 0.1% | F | 1830 | 1.3% | F |
| | Example | | | | | | | | | | | | | | | |
| B5 | Comparative | Crystalline | 5 | Amorphous | 150 | 0.0 | 39.8 | 39.2 | 21.0 | 30.2 | 16.9% | −0.2% | F | 1880 | 0.9% | F |
| | Example | | | | | | | | | | | | | | | |
| B6 | Comparative | Crystalline | 5 | Amorphous | 200 | 0.0 | 40.6 | 38.8 | 20.6 | 30.2 | 16.9% | 0.0% | F | 1920 | 0.2% | F |
| | Example | | | | | | | | | | | | | | | |
| B7 | Example | Crystalline | 15 | Amorphous | 5 | 3.0 | 40.9 | 38.9 | 20.2 | 30.3 | 10.5% | 6.5% | G | 1620 | 6.2% | G |
| B8 | Comparative | Crystalline | 15 | Amorphous | 15 | 1.0 | 40.5 | 39.5 | 20.0 | 30.1 | 15.2% | 1.7% | F | 1610 | 6.1% | G |
| | Example .. | | | | | | | | | | | | | | | |
| B9 | Comparative | Crystalline | 15 | Amorphous | 50 | 0.3 | 41.5 | 39.1 | 19.4 | 30.7 | 16.9% | 0.3% | F | 1670 | 5.8% | G |
| | Example | | | | | | | | | | | | | | | |
| B10 | Comparative | Crystalline | 15 | Amorphous | 100 | 0.2 | 41.5 | 40.9 | 17.6 | 30.4 | 17.3% | 0.1% | F | 1780 | 6.3% | G |
| | Example | | | | | | | | | | | | | | | |
| B11 | Comparative | Crystalline | 15 | Amorphous | 150 | 0.1 | 41.4 | 40.2 | 18.4 | 30.0 | 17.2% | 0.1% | F | 1810 | 5.0% | G |
| | Example | | | | | | | | | | | | | | | |
| B12 | Comparative | Crystalline | 15 | Amorphous | 200 | 0.1 | 38.7 | 39.1 | 22.2 | 30.4 | 16.3% | 0.1% | F | 1720 | 5.5% | G |
| | Example | | | | | | | | | | | | | | | |
| B13 | Example | Crystalline | 50 | Amorphous | 5 | 10.0 | 40.9 | 40.4 | 18.7 | 30.8 | 8.9% | 5.9% | G | 1420 | 14.5% | VG |
| B14 | Example | Crystalline | 50 | Amorphous | 15 | 3.3 | 38.5 | 40.2 | 21.3 | 30.4 | 9.1% | 5.1% | G | 1350 | 14.9% | VG |
| B15 | Comparative | Crystalline | 50 | Amorphous | 50 | 1.0 | 40.1 | 41.0 | 18.9 | 30.4 | 13.1% | 1.7% | F | 1430 | 14.6% | VG |
| | Example .. | | | | | | | | | | | | | | | |
| B16 | Comparative | Crystalline | 50 | Amorphous | 100 | 0.5 | 39.3 | 40.5 | 20.2 | 30.9 | 13.4% | 1.1% | F | 1500 | 14.1% | VG |
| | Example | | | | | | | | | | | | | | | |
| B17 | Comparative | Crystalline | 50 | Amorphous | 150 | 0.3 | 40.8 | 40.0 | 19.2 | 30.9 | 14.0% | 0.7% | F | 1550 | 13.6% | VG |
| | Example | | | | | | | | | | | | | | | |
| B18 | Comparative | Crystalline | 50 | Amorphous | 200 | 0.3 | 39.7 | 39.6 | 20.7 | 31.0 | 14.3% | 0.2% | F | 1510 | 14.9% | VG |
| | Example | | | | | | | | | | | | | | | |
| B19 | Example | Crystalline | 100 | Amorphous | 5 | 20.0 | 39.2 | 38.6 | 22.2 | 30.2 | 7.7% | 5.5% | G | 1380 | 12.4% | VG |
| B20 | Example | Crystalline | 100 | Amorphous | 15 | 6.7 | 40.9 | 40.2 | 18.9 | 31.0 | 7.9% | 5.7% | G | 1390 | 14.9% | VG |
| B21 | Example | Crystalline | 100 | Amorphous | 50 | 2.0 | 40.8 | 40.9 | 18.3 | 30.3 | 8.4% | 5.5% | G | 1420 | 15.4% | VG |
| B22 | Comparative | Crystalline | 100 | Amorphous | 100 | 1.0 | 38.6 | 40.4 | 21.0 | 30.4 | 10.4% | 2.9% | F | 1480 | 13.6% | VG |
| | Example | | | | | | | | | | | | | | | |
| B23 | Comparative | Crystalline | 100 | Amorphous | 150 | 0.7 | 39.2 | 40.8 | 20.0 | 30.9 | 11.6% | 1.9% | F | 1530 | 12.9% | VG |
| | Example | | | | | | | | | | | | | | | |
| B24 | Comparative | Crystalline | 100 | Amorphous | 200 | 0.5 | 39.0 | 41.3 | 19.7 | 30.4 | 11.8% | 1.8% | F | 1570 | 11.5% | VG |
| | Example | | | | | | | | | | | | | | | |
| B25 | Example | Crystalline | 150 | Amorphous | 5 | 30.0 | 39.1 | 41.4 | 19.5 | 30.7 | 7.5% | 6.2% | G | 1320 | 15.2% | VG |
| B26 | Example | Crystalline | 150 | Amorphous | 15 | 10.0 | 39.7 | 39.2 | 21.1 | 30.2 | 7.9% | 5.4% | G | 1330 | 12.8% | VG |
| B27 | Example | Crystalline | 150 | Amorphous | 50 | 3.0 | 38.6 | 39.3 | 22.1 | 30.5 | 8.1% | 5.1% | G | 1320 | 14.1% | VG |
| B28 | Example | Crystalline | 150 | Amorphous | 100 | 1.5 | 40.7 | 40.9 | 18.4 | 30.2 | 8.5% | 5.3% | G | 1480 | 13.6% | VG |
| B29 | Comparative | Crystalline | 150 | Amorphous | 150 | 1.0 | 41.2 | 40.4 | 18.4 | 30.9 | 11.0% | 2.8% | F | 1480 | 14.7% | VG |
| | Example | | | | | | | | | | | | | | | |
| B30 | Comparative | Crystalline | 150 | Amorphous | 200 | 0.8 | 38.6 | 38.8 | 22.6 | 30.1 | 11.8% | 1.3% | F | 1530 | 7.7% | G |
| | Example | | | | | | | | | | | | | | | |
| B31 | Example | Crystalline | 200 | Amorphous | 5 | 40.0 | 40.8 | 39.4 | 19.8 | 30.7 | 6.5% | 5.3% | G | 1380 | 7.8% | G |
| B32 | Example | Crystalline | 200 | Amorphous | 15 | 13.3 | 40.4 | 38.5 | 21.1 | 30.4 | 6.4% | 5.1% | G | 1380 | 5.6% | G |
| B33 | Example | Crystalline | 200 | Amorphous | 50 | 4.0 | 39.0 | 40.2 | 20.8 | 30.8 | 6.2% | 5.5% | G | 1400 | 6.3% | G |
| B34 | Example | Crystalline | 200 | Amorphous | 100 | 2.0 | 40.4 | 39.8 | 19.8 | 30.7 | 6.5% | 5.3% | G | 1520 | 5.8% | G |
| B35 | Example | Crystalline | 200 | Amorphous | 150 | 1.3 | 39.0 | 41.4 | 19.6 | 30.0 | 6.8% | 5.1% | G | 1530 | 6.4% | G |
| B36 | Comparative | Crystalline | 200 | Amorphous | 200 | 1.0 | 38.6 | 39.1 | 22.3 | 30.6 | 8.0% | 3.5% | F | 1540 | 3.4% | F |
| | Example | | | | | | | | | | | | | | | |

TABLE 3

| | | First large particles | | Second large particles | | | Mixing ratio of metal magnetic particles | | | Magnetic | | | | Core loss | | |
|---|---|---|---|---|---|---|---|---|---|---|---|---|---|---|---|---|
| | Example/ | | Coating | | Coating | | First large | Second large | Small | permeability | DC bias characteristics | | | Measured | Improve- | |
| Sample | Comparative | Particle | thickness | Particle | thickness | | particles | particles | particles | μi | Measured | Difference from | Deter- | value | ment | Deter- |
| No. | Example | structure | T1 (nm) | structure | T2 (nm) | T1/T2 | AL₁/A0 (%) | AL₂/A0 (%) | AS/A0 (%) | (−) | value (%) | expected value | mination | (kW/m³) | rate (%) | mination |
| C1 | Comparative | Crystalline | 5 | Nanocrystal | 5 | 1.0 | 40.0 | 39.8 | 20.2 | 30.1 | 18.4% | 1.5% | F | 1350 | 6.6% | G |
| | Example | | | | | | | | | | | | | | | |
| C2 | Comparative | Crystalline | 5 | Nanocrystal | 15 | 0.3 | 39.7 | 39.5 | 20.8 | 30.3 | 18.3% | 1.4% | F | 1340 | 7.1% | G |
| | Example | | | | | | | | | | | | | | | |
| C3 | Comparative | Crystalline | 5 | Nanocrystal | 50 | 0.1 | 40.3 | 40.2 | 19.5 | 30.0 | 18.3% | 1.8% | F | 1350 | 8.2% | G |
| | Example | | | | | | | | | | | | | | | |
| C4 | Comparative | Crystalline | 5 | Nanocrystal | 100 | 0.1 | 40.5 | 40.5 | 19.0 | 30.5 | 18.6% | 1.4% | F | 1350 | 8.7% | G |
| CS | Comparative | Crystalline | 5 | Nanocrystal | 150 | 0.0 | 39.7 | 39.7 | 20.6 | 30.4 | 18.3% | 1.4% | F | 1340 | 8.0% | G |
| | Example | | | | | | | | | | | | | | | |
| C6 | Comparative | Crystalline | 5 | Nanocrystal | 200 | 0.0 | 39.7 | 40.5 | 19.8 | 30.4 | 18.5% | 1.4% | F | 1320 | 9.8% | G |
| | Example | | | | | | | | | | | | | | | |
| C7 | Example | Crystalline | 15 | Nanocrystal | 5 | 3.0 | 40.4 | 40.2 | 19.4 | 30.1 | 14.8% | 5.2% | G | 1250 | 10.9% | VG |
| C8 | Comparative | Crystalline | 15 | Nanocrystal | 15 | 1.0 | 39.6 | 39.7 | 20.7 | 30.3 | 17.6% | 2.0% | F | 1240 | 10.7% | VG |
| | Example | | | | | | | | | | | | | | | |
| C9 | Comparative | Crystalline | 15 | Nanocrystal | 50 | 0.3 | 40.2 | 39.6 | 20.2 | 30.0 | 17.9% | 2.0% | F | 1230 | 12.7% | VG |
| | Example | | | | | | | | | | | | | | | |
| C10 | Comparative | Crystalline | 15 | Nanocrysta | 100 | 0.2 | 40.4 | 39.6 | 20.0 | 30.4 | 18.3% | 1.5% | F | 1220 | 13.9% | VG |
| | Example | | | | | | | | | | | | | | | |
| C11 | Comparative | Crystalline | 15 | Nanocrystal | 150 | 0.1 | 39.7 | 40.2 | 20.1 | 30.3 | 18.4% | 1.4% | F | 1210 | 14.1% | VG |
| | Example | | | | | | | | | | | | | | | |
| C12 | Comparative | Crystalline | 15 | Nanocrystal | 200 | 0.1 | 40.4 | 40.3 | 19.3 | 30.0 | 18.5% | 1.5% | F | 1200 | 15.8% | VG |
| | Example | | | | | | | | | | | | | | | |
| C13 | Example | Crystalline | 50 | Nanocrystal | 5 | 10.0 | 40.4 | 40.3 | 19.3 | 30.1 | 12.1% | 5.6% | G | 1100 | 16.5% | VG |
| C14 | Example | Crystalline | 50 | Nanocrystal | 15 | 3.3 | 39.6 | 39.6 | 20.8 | 30.1 | 12.3% | 5.0% | G | 1080 | 16.9% | VG |
| C15 | Comparative | Crystalline | | Nanocrystal | 50 | 1.0 | 39.8 | 39.9 | 20.3 | 30.2 | 14.6% | 2.9% | F | 1050 | 20.0% | VG |
| | Example | | | | | | | | | | | | | | | |
| C16 | Comparative | Crystalline | 50 | Nanocrystal | 100 | 0.5 | 39.8 | 39.8 | 20.4 | 30.5 | 15.1% | 2.2% | F | 1100 | 16.1% | VG |
| | Example | | | | | | | | | | | | | | | |
| C17 | Comparative | Crystalline | 50 | Nanocrystal | 150 | 0.3 | 40.4 | 40.4 | 19.2 | 30.0 | 15.3% | 2.3% | F | 1120 | 16.3% | VG |
| | Example | | | | | | | | | | | | | | | |
| C18 | Comparative | Crystalline | 50 | Nanocrystal | 200 | 0.3 | 40.0 | 39.6 | 20.4 | 30.4 | 15.6% | 1.8% | F | 1100 | 16.9% | VG |
| | Example | | | | | | | | | | | | | | | |
| C19 | Example | Crystalline | 100 | Nanocrystal | 5 | 20.0 | 40.2 | 40.3 | 19.5 | 30.0 | 11.1% | 5.5% | G | 1100 | 15.1% | VG |
| C20 | Example | Crystalline | 100 | Nanocrystal | 15 | 6.7 | 40.1 | 40.0 | 19.9 | 30.2 | 10.2% | 6.3% | G | 1110 | 14.7% | VG |
| C21 | Example | Crystalline | 100 | Nanocrystal | 50 | 2.0 | 39.6 | 39.8 | 20.6 | 30.3 | 10.4% | 6.0% | G | 1090 | 15.6% | VG |
| C22 | Comparative | Crystalline | 100 | Nanocrystal | 100 | 1.0 | 39.6 | 40.3 | 20.1 | 30.5 | 13.1% | 3.3% | F | 1081 | 16.8% | VG |
| | Example | | | | | | | | | | | | | | | |
| C23 | Comparative | Crystalline | 100 | Nanocrystal | 150 | 0.7 | 39.9 | 39.7 | 20.4 | 30.5 | 13.2% | 3.2% | F | 1080 | 17.4% | VG |
| | Example | | | | | | | | | | | | | | | |
| C24 | Comparative | Crystalline | 100 | Nanocrystal | 200 | 0.5 | 39.8 | 39.6 | 20.6 | 30.1 | 13.1% | 3.2% | F | 1070 | 18.0% | VG |
| | Example | | | | | | | | | | | | | | | |
| C25 | Example | Crystalline | 150 | Nanocrystal | 5 | 30.0 | 40.1 | 40.2 | 19.7 | 30.2 | 10.2% | 6.4% | G | 1000 | 18.9% | VG |
| C26 | Example | Crystalline | 150 | Nanocrystal | 15 | 10.0 | 40.1 | 39.6 | 20.3 | 30.2 | 9.9% | 6.5% | G | 990 | 20.0% | VG |
| C27 | Example | Crystalline | 150 | Nanocrystal | 50 | 3.0 | 39.6 | 39.7 | 20.7 | 30.3 | 9.8% | 6.6% | G | 980 | 20.4% | VG |
| C28 | Example | Crystalline | 150 | Nanocrystal | 100 | 1.5 | 39.9 | 40.5 | 19.6 | 30.0 | 10.1% | 6.4% | G | 970 | 22.2% | VG |
| C29 | Comparative | Crystalline | 150 | Nanocrystal | 150 | 1.0 | 40.5 | 40.0 | 19.5 | 30.3 | 13.1% | 3.4% | F | 990 | 21.5% | VG |
| | Example | | | | | | | | | | | | | | | |
| C30 | Comparative | Crystalline | 150 | Nanocrystal | 200 | 0.8 | 39.9 | 40.4 | 19.7 | 30.2 | 13.3% | 3.2% | F | 980 | 21.7% | VG |
| | Example | | | | | | | | | | | | | | | |
| C31 | Example | Crystalline | 200 | Nanocrystal | 5 | 40.0 | 40.4 | 39.6 | 20.0 | 30.4 | 8.9% | 5.8% | G | 990 | 15.0% | VG |
| C32 | Example | Crystalline | 200 | Nanocrystal | 15 | 13.3 | 40.3 | 40.1 | 19.6 | 30.3 | 8.7% | 6.0% | G | 980 | 16.5% | VG |
| C33 | Example | Crystalline | 200 | Nanocrystal | 50 | 4.0 | 39.9 | 40.1 | 20.0 | 30.3 | 8.8% | 6.0% | G | 970 | 17.3% | VG |
| C34 | Example | Crystalline | 200 | Nanocrystal | 100 | 2.0 | 39.5 | 40.1 | 20.4 | 30.5 | 8.3% | 6.3% | G | 990 | 15.1% | VG |
| C35 | Example | Crystalline | 200 | Nanocrystal | 150 | 1.3 | 40.2 | 40.2 | 19.6 | 30.1 | 9.5% | 5.3% | G | 970 | 18.2% | VG |
| C36 | Comparative | Crystalline | 200 | Nanocrystal | 200 | 1.0 | 40.4 | 40.1 | 19.5 | 30.4 | 12.2% | 2.6% | F | 980 | 17.6% | VG |
| | Example | | | | | | | | | | | | | | | |

Table 2 shows evaluation results of samples in which the crystalline first large particles and the amorphous second large particles were mixed. In any of comparative examples in which T1/T2 is 1.0 or less, the DC bias characteristics was determined as failed, and the DC bias characteristics were similar to the expected value calculated from the mixing ratio or worse than the expected value. In addition, in comparative examples in which T1 is 5 nm or 200 nm, not only the DC bias characteristics but also the core loss was determined as failed.

On the other hand, in any of examples in which T1/T2 is more than 1.0, DC bias characteristics better than the expected value were obtained, and the core loss could also be reduced from the expected value by 5% or more. From the results, it could be understood that the core loss characteristics and the DC bias characteristics can be improved in a compatible manner not only by simply mixing the crystalline first large particles and the amorphous second large particle but also by satisfying a relationship of T1>T2.

Note that, from the evaluation results of the examples shown in Table 2, it could be understood that T2 is preferably 5 to 50 nm, and according to this, the core loss can be further lowered. In addition, it could be understood that as T1 is made to be thicker, the variation rate of the magnetic permeability further decreases, and the DC bias characteristics become better.

Table 3 shows evaluation results of samples in which crystalline first large particles and nanocrystalline second large particles were mixed. Even in Table 3, similar evaluation results as in Table 2 were obtained, and in examples in which T1/T2 is more than 1.0 as shown in Table 3, DC bias characteristics better than the expected value were obtained, and the core loss could be reduced from the expected value by 5% or more. From the results, it could be understood that the core loss characteristics and the DC bias characteristics could be improved in a compatible manner not only by simply mixing the crystalline first large particles and the nanocrystalline second large particles, but also by satisfying a relationship of T1>T2.

When comparing the evaluation results in Table 2 and the evaluation results in Table 3 from each other, in examples using the amorphous second large particles as shown in Table 2, the variation rate of the magnetic permeability was smaller and the DC bias characteristics were more excellent in comparison to examples using the nanocrystalline second large particles as shown in Table 3. On the other hand, in examples using the nanocrystalline second large particles as shown in Table 3, the core loss could be further lowered in comparison to the examples shown in Table 2. From the results, it could be understood that it is preferable to mix the crystalline first large particles and the amorphous second large particles from the viewpoint of obtaining excellent DC bias characteristics, and it is preferable to mix the crystalline first large particles and the nanocrystalline second large particles from the viewpoint of further lowering the core loss.

### Experiment 3

In Experiment 3, 16 kinds of magnetic cores (Sample D1 to Sample D16) shown in Table 3 were manufactured by changing a composition of the insulation coating provided in the first large particles and the second large particles. In all samples in Experiment 3, the first large particles were the Fe—Si-based alloy having the crystalline structure, and the average thickness T1 of the insulation coating of the first large particles was set to 100 nm. In Sample D1 to Sample D8, the second large particles were the Fe—Co—B—P—Si—Cr alloy having the amorphous structure, and the average thickness T2 of the insulation coating of the second large particles was set to 15 nm. In Sample D9 to Sample D16, the second large particles were the Fe—Si—B—Nb—Cu-based alloy having the nanocrystal structure, and the average thickness T2 of the insulation coating of the second large particles was set to 15 nm.

In Sample D1 to Sample D8, manufacturing conditions other than the composition of the insulation coating were set to be similar to the manufacturing conditions of the sample B20 in Experiment 2, and in Sample D9 to Sample D16, manufacturing conditions other than the composition of the insulation coating were set to be similar to the manufacturing conditions of the sample C20 in Experiment 2. Similar evaluation as in Experiment 1 was performed on the respective samples in Experiment 3. Evaluation results of the respective samples in Experiment 3 are shown in Table 4.

TABLE 4

| | | First large particles | | | Second large particles | | |
|---|---|---|---|---|---|---|---|
| | Example/ | | | Coating | | | Coating |
| Sample | Comparative | Particle | | thickness | Particle | | thickness |
| No. | Example | structure | Coating composition | T1 (nm) | structure | Coating composition | T2 (nm) |
| B20 | Example | Crystalline | P—Zn—Al—O-based | 100 | Amorphous | P—Zn—Al—O-based | 15 |
| DI | Example | Crystalline | P—Zn—Al—O-based | 100 | Amorphous | Bi—Zn—B—Si—O-based | 15 |
| D2 | Example | Crystalline | P—Zn—Al—O-based | 100 | Amorphous | Ba—Zn—B—Si—Al—O-based | 15 |
| D3 | Example | Crystalline | Bi—Zn—B—Si—O-based | 100 | Amorphous | P—Zn—Al—O-based | 15 |
| D4 | Example | Crystalline | Bi—Zn—B—Si—O-based | 100 | Amorphous | Bi—Zn—B—Si—O-based | 15 |
| D5 | Example | Crystalline | Bi—Zn—B—Si—O-based | 100 | Amorphous | Ba—Zn—B—Si—Al—O-based | 15 |
| D6 | Example | Crystalline | Ba—Zn—B—Si—Al—O-based | 100 | Amorphous | P—Zn—Al—O-based | 15 |
| D7 | Example | Crystalline | Ba—Zn—B—Si—Al—O-based | 100 | Amorphous | Bi—Zn—B—Si—O-based | 15 |
| D8 | Example | Crystalline | Ba—Zn—B—Si—Al—O-based | 100 | Amorphous | Ba—Zn—B—Si—Al—O-based | 15 |
| C20 | Example | Crystalline | P—Zn—Al—O-based | 100 | Nanocrystal | P—Zn—Al—O-based | 15 |
| D9 | Example | Crystalline | P—Zn—Al—O-based | 100 | Nanocrystal | Bi—Zn—B—Si—O-based | 15 |
| D10 | Example | Crystalline | P—Zn—Al—O-based | 100 | Nanocrystal | Ba—Zn—B—Si—Al—O-based | 15 |
| DI | Example | Crystalline | Bi—Zn—B—Si—O-based | 100 | Nanocrystal | P—Zn—Al—O-based | 15 |
| D12 | Example | Crystalline | Bi—Zn—B—Si—O-based | 100 | Nanocrystal | Bi—Zn—B—Si—O-based | 15 |
| D13 | Example | Crystalline | Bi—Zn—B—Si—O-based | 100 | Nanocrystal | Ba—Zn—B—Si—Al—O-based | 15 |
| D14 | Example | Crystalline | Ba—Zn—B—Si—Al—O-based | 100 | Nanocrystal | P—Zn—Al—O-based | 15 |
| D15 | Example | Crystalline | Ba—Zn—B—Si—Al—O-based | 100 | Nanocrystal | Bi—Zn—B—Si—O-based | 15 |
| D16 | Example | Crystalline | Ba—Zn—B—Si—Al—O-based | 100 | Nanocrystal | Ba—Zn—B—Si—Al—O-based | 15 |
| | | Mixing ratio of | | | | | |
| | | metal magnetic particles | | | Magnetic | | |
| | | First large | Second large | Small | permeability | | |
| | Sample | particles | particles | particles | μi | DC bias | Core loss |
| | No. | AL₁/A0 (%) | AL₂/A0 (%) | AS/A0 (%) | (−) | characteristics | (kW/m³) |
| | B20 | 40.9 | 40.2 | 18.9 | 31.0 | 7.9% | 1390 |
| | DI | 41.2 | 39.3 | 19.5 | 30.0 | 7.4% | 1400 |
| | D2 | 39.0 | 41.3 | 19.7 | 30.2 | 7.5% | 1380 |
| | D3 | 38.8 | 41.0 | 20.2 | 30.1 | 7.4% | 1370 |
| | D4 | 40.9 | 41.1 | 18.0 | 29.6 | 8.0% | 1380 |
| | D5 | 38.9 | 41.5 | 19.6 | 30.0 | 7.5% | 1360 |
| | D6 | 41.3 | 39.1 | 19.6 | 30.3 | 7.8% | 1360 |
| | D7 | 38.9 | 39.0 | 22.1 | 30.4 | 7.4% | 1320 |
| | D8 | 39.8 | 39.0 | 21.2 | 30.1 | 8.1% | 1350 |
| | C20 | 40.1 | 40.0 | 19.9 | 30.2 | 10.2% | 1110 |
| | D9 | 39.9 | 40.5 | 19.6 | 30.1 | 8.9% | 1100 |
| | D10 | 40.3 | 39.4 | 20.3 | 29.6 | 8.8% | 1110 |
| | DI | 38.7 | 41.1 | 20.2 | 29.9 | 9.1% | 1080 |
| | D12 | 38.9 | 39.6 | 21.5 | 30.3 | 10.2% | 1090 |
| | D13 | 38.6 | 39.3 | 22.1 | 30.3 | 8.8% | 1070 |
| | D14 | 41.4 | 39.8 | 18.8 | 30.3 | 8.8% | 1110 |
| | D15 | 39.6 | 39.4 | 21.0 | 30.2 | 9.1% | 1090 |
| | D16 | 39.6 | 41.0 | 19.4 | 29.7 | 10.3% | 1070 |

In Sample D1 to Sample D8 in Experiment 3, the DC bias characteristics and the core loss were similar as in Sample B20 in Experiment 2, and good DC bias characteristics and a low core loss were compatible with each other. In addition, in Sample D9 to Sample D16 in Experiment 3, the DC bias characteristics and the core loss were similar as in Sample C20 in Experiment 2, and good DC bias characteristics and low core loss were compatible with each other. From the results, it could be understood that the composition of the insulation coating formed on each of the large particles can be arbitrarily set. In addition, it could be understood that the composition of the insulation coating of the first large particles having the crystalline structure and the composition of the insulation coating of the second large particles having the amorphous structure or the nanocrystal structure may match each other or may be different from each other.

### Experiment 4

In Experiment 4, magnetic core samples shown in Table 5 and Table 6 were manufactured by changing the ratio (AL₁/A0) of the first large particles, and the ratio of (AL₂/A0) of the second large particles. In any of respective samples in Experiment 4, the total area ratio A0 of the metal magnetic particles on the cross-section of the magnetic core was within a range of 80±2%, and the ratio (AS/A0) of the small particles was within a range of 20±2.5%

Sample E1 to Sample E18 shown in Table 5 are samples in which the crystalline first large particles and the amorphous second large particles are mixed. In Sample E1 to Sample E6 as comparative examples in Table 5, T1 was set to 15 nm and T2 was set to 100 nm, and manufacturing conditions other than the ratio of the large particles in Sample E1 to Sample E6 were set to be similar as in Sample B10 in Experiment 2. In Sample E7 to Sample E12 as comparative examples in Table 5, T1 and T2 were set to 15 nm, and manufacturing conditions other than the ratio of the large particles in Sample E7 to Sample E12 were set to be similar as in Sample B8 in Experiment 2. On the other hand, in Sample E13 to Sample E18 as examples in Table 5, T1 was set to 100 nm, T2 was set to 15 nm, and manufacturing conditions other than the ratio of the large particles, and manufacturing conditions other than the ratio of the large particles in Sample E13 to Sample E18 were set to be similar as in Sample B20 in Experiment 2.

In addition, any of Sample F1 to Sample F18 shown in Table 6 is a sample in which the crystalline first large particles and the nanocrystalline second large particles are mixed. In Sample F1 to Sample F6 as comparative examples in Table 6, T1 was set to 15 nm, T2 was set to 100 nm, and manufacturing conditions other than the ratio of the large particles in Sample F1 to Sample F6 were set to be similar as in Sample C10 in Experiment 2. In Sample F7 to Sample F12 as comparative examples in Table 6, T1 and T2 were set to 15 nm, and manufacturing conditions other than the ratio of the large particles in Sample F7 to Sample F12 were set to be similar as in Sample C8 in Experiment 2. On the other hand, in Sample F13 to Sample F18 as examples in Table 6, T1 was set to 100 nm, T2 was set to 15 nm, and manufacturing conditions other than the ratio of the large particles in Sample F13 to Sample F18 were set to be similar as in Sample C20 in Experiment 2.

In Experiment 4, similar evaluation as in Experiment 2 was performed. Evaluation results are shown in Table 5 and Table 6.

TABLE 5

| | | First large particles | | Second large particles | | Mixing ratio of metal magnetic particles | | | Magnetic | DC bias characteristics | | | Core loss | | |
|---|---|---|---|---|---|---|---|---|---|---|---|---|---|---|---|
| | Example/ | | Coating | | Coating | First large | Second large | Small | permeability | Measured | Difference from | | Measured | Improvement | |
| Sample | Comparative | Particle | thickness | Particle | thickness | particles | particles | particles | μi | value | expected value | Deter- | value | rate | Deter- |
| No. | Example | structure | T1 (nm) | structure | T2 (nm) | AL₁/A0 (%) | AL₂/A0 (%) | AS/A0 (%) | (−) | (%) | (%) | mination | (kW/m³) | (%) | mination |
| E1 | Comparative | Crystalline | 15 | Amorphous | 100 | 78.9 | 0.7 | 20.4 | 30.3 | 20.1% | 0.0% | F | 2040 | 7.4% | G |
| | Example | | | | | | | | | | | | | | |
| E2 | Comparative | Crystalline | 15 | Amorphous | 100 | 75.6 | 3.9 | 20.5 | 29.6 | 19.2% | 0.6% | F | 2040 | 6.0% | G |
| | Example | | | | | | | | | | | | | | |
| E3 | Comparative | Crystalline | 15 | Amorphous | 100 | 59.9 | 20.0 | 20.1 | 29.7 | 18.3% | 0.2% | F | 1920 | 5.3% | G |
| | Example | | | | | | | | | | | | | | |
| B10 | Comparative | Crystalline | 15 | Amorphous | 100 | 41.5 | 40.9 | 17.6 | 30.4 | 17.3% | 0.1% | F | 1780 | 6.3% | G |
| | Example | | | | | | | | | | | | | | |
| E4 | Comparative | Crystalline | 15 | Amorphous | 100 | 20.5 | 59.9 | 19.6 | 30.0 | 15.1% | 0.2% | F | 1560 | 6.3% | G |
| | Example | | | | | | | | | | | | | | |
| E5 | Comparative | Crystalline | 15 | Amorphous | 100 | 4.0 | 76.1 | 19.9 | 30.2 | 13.5% | 0.3% | F | 1420 | 5.7% | G |
| | Example | | | | | | | | | | | | | | |
| E6 | Comparative | Crystalline | 15 | Amorphous | 100 | 1.6 | 78.9 | 19.5 | 29.8 | 13.6% | 0.1% | F | 1390 | 6.7% | G |
| | Example | | | | | | | | | | | | | | |
| E7 | Comparative | Crystalline | 15 | Amorphous | 15 | 79.1 | 0.6 | 20.3 | 30.3 | 19.6% | 0.5% | F | 2080 | 5.6% | G |
| | Example | | | | | | | | | | | | | | |
| E8 | Comparative | Crystalline | 15 | Amorphous | 15 | 76.0 | 4.0 | 20.0 | 30.3 | 19.0% | 0.9% | F | 2050 | 5.5% | G |
| | Example | | | | | | | | | | | | | | |
| E9 | Comparative | Crystalline | 15 | Amorphous | 15 | 60.2 | 19.9 | 19.9 | 30.1 | 17.3% | 1.3% | F | 1850 | 5.9% | G |
| | Example | | | | | | | | | | | | | | |
| B8 | Comparative | Crystalline | 15 | Amorphous | 15 | 40.5 | 39.5 | 20.0 | 30.1 | 15.2% | 1.7% | F | 1610 | 6.1% | G |
| | Example | | | | | | | | | | | | | | |
| E10 | Comparative | Crystalline | 15 | Amorphous | 15 | 19.9 | 59.8 | 20.3 | 30.4 | 13.8% | 1.2% | F | 1370 | 5.4% | G |
| | Example | | | | | | | | | | | | | | |
| E11 | Comparative | Crystalline | 15 | Amorphous | 15 | 3.7 | 76.4 | 19.9 | 30.1 | 12.1% | 1.6% | F | 1150 | 7.7% | G |
| | Example | | | | | | | | | | | | | | |
| E12 | Comparative | Crystalline | 15 | Amorphous | 15 | 0.8 | 78.9 | 20.3 | 29.6 | 11.6% | 1.8% | F | 1120 | 7.1% | G |
| | Example | | | | | | | | | | | | | | |
| E13 | Example | Crystalline | 100 | Amorphous | 15 | 79.5 | 0.7 | 19.8 | 30.4 | 8.5% | 5.1% | G | 1750 | 13.1% | VG |
| E14 | Example | Crystalline | 100 | Amorphous | 15 | 76.3 | 3.7 | 20.0 | 30.0 | 8.2% | 5.3% | G | 1700 | 14.0% | VG |
| E15 | Example | Crystalline | 100 | Amorphous | 15 | 60.7 | 19.7 | 19.6 | 29.8 | 8.2% | 5.4% | G | 1580 | 13.4% | VG |
| B20 | Example | Crystalline | 100 | Amorphous | 15 | 40.9 | 40.2 | 18.9 | 31.0 | 7.9% | 5.7% | G | 1390 | 14.9% | VG |
| E16 | Example | Crystalline | 100 | Amorphous | 15 | 20.3 | 59.9 | 19.8 | 29.5 | 8.1% | 5.3% | G | 1200 | 14.8% | VG |
| E17 | Example | Crystalline | 100 | Amorphous | 15 | 3.9 | 76.4 | 19.7 | 29.9 | 8.2% | 5.2% | G | 1040 | 16.2% | VG |
| E18 | Example | Crystalline | 100 | Amorphous | 15 | 0.5 | 79.1 | 20.4 | 30.4 | 8.2% | 5.1% | G | 1010 | 15.6% | VG |

TABLE 6

| | | First large particles | | Second large particles | | Mixing ratio of metal magnetic particles | | | Magnetic | DC bias characteristics | | | Core loss | | |
|---|---|---|---|---|---|---|---|---|---|---|---|---|---|---|---|
| | Example/ | | Coating | | Coating | First large | Second large | Small | permeability | Measured | Difference from | | Measured | Improvement | |
| Sample | Comparative | Particle | thickness | Particle | thickness | particles | particles | particles | μi | value | expected value | Deter- | value | rate | Deter- |
| No. | Example | structure | T1 (nm) | structure | T2 (nm) | AL₁/A0 (%) | AL₂/A0 (%) | AS/A0 (%) | (−) | (%) | (%) | mination | (kW/m³) | (%) | mination |
| F1 | Comparative | Crystalline | 15 | Nanocrystal | 100 | 78.9 | 0.7 | 20.4 | 29.8 | 19.5% | 0.7% | F | 1990 | 9.3% | G |
| | Example | | | | | | | | | | | | | | |
| F2 | Comparative | Crystalline | 15 | Nanocrystal | 100 | 76.2 | 4.0 | 19.8 | 30.0 | 19.4% | 0.9% | F | 1870 | 12.7% | VG |
| | Example | | | | | | | | | | | | | | |
| F3 | Comparative | Crystalline | 15 | Nanocrystal | 100 | 60.2 | 20.0 | 19.8 | 30.3 | 19.0% | 1.1% | F | 1580 | 13.1% | VG |
| | Example | | | | | | | | | | | | | | |
| C10 | Comparative | Crystalline | 15 | Nanocrystal | 100 | 40.4 | 39.6 | 20.0 | 30.4 | 18.3% | 1.5% | F | 1220 | 13.9% | VG |
| | Example | | | | | | | | | | | | | | |
| F4 | Comparative | Crystalline | 15 | Nanocrystal | 100 | 20.4 | 60.0 | 19.6 | 29.8 | 18.1% | 1.5% | F | 890 | 12.1% | VG |
| | Example | | | | | | | | | | | | | | |
| F5 | Comparative | Crystalline | 15 | Nanocrystal | 100 | 3.7 | 76.2 | 20.1 | 30.3 | 18.7% | 0.6% | F | 620 | 7.7% | G |
| | Example | | | | | | | | | | | | | | |
| F6 | Comparative | Crystalline | 15 | Nanocrystal | 100 | 1.2 | 78.9 | 19.9 | 29.9 | 18.9% | 0.4% | F | 600 | 3.5% | F |
| | Example | | | | | | | | | | | | | | |
| F7 | Comparative | Crystalline | 15 | Nanocrystal | 15 | 79.1 | 0.9 | 20.0 | 29.8 | 19.8% | 0.5% | F | 1970 | 10.5% | VG |
| | Example | | | | | | | | | | | | | | |
| F8 | Comparative | Crystalline | 15 | Nanocrystal | 15 | 76.3 | 4.1 | 19.6 | 30.1 | 19.3% | 1.0% | F | 1880 | 12.3% | VG |
| | Example | | | | | | | | | | | | | | |
| F9 | Comparative | Crystalline | 15 | Nanocrystal | 15 | 59.7 | 20.1 | 20.2 | 29.7 | 18.8% | 1.2% | F | 1600 | 11.2% | VG |
| | Example | | | | | | | | | | | | | | |
| C8 | Comparative | Crystalline | 15 | Nanocrystal | 15 | 39.6 | 39.7 | 20.7 | 30.3 | 17.6% | 2.0% | F | 1240 | 10.7% | VG |
| | Example | | | | | | | | | | | | | | |
| F10 | Comparative | Crystalline | 15 | Nanocrystal | 15 | 20.4 | 60.1 | 19.5 | 30.3 | 18.1% | 1.6% | F | 890 | 11.2% | VG |
| | Example | | | | | | | | | | | | | | |
| F11 | Comparative | Crystalline | 15 | Nanocrystal | 15 | 3.9 | 76.2 | 19.9 | 30.1 | 18.9% | 0.5% | F | 600 | 9.6% | G |
| | Example | | | | | | | | | | | | | | |
| F12 | Comparative | Crystalline | 15 | Nanocrystal | 15 | 1.0 | 78.9 | 20.1 | 29.7 | 19.1% | 0.3% | F | 590 | 2.1% | F |
| | Example | | | | | | | | | | | | | | |
| F13 | Example | Crystalline | 100 | Nanocrystal | 15 | 79.4 | 0.9 | 19.7 | 30.2 | 8.3% | 5.3% | G | 1800 | 10.3% | VG |
| F14 | Example | Crystalline | 100 | Nanocrystal | 15 | 76.3 | 4.1 | 19.6 | 29.9 | 8.5% | 5.4% | G | 1750 | 10.3% | VG |
| F15 | Example | Crystalline | 100 | Nanocrystal | 15 | 60.1 | 20.2 | 19.7 | 30.4 | 9.4% | 5.7% | G | 1420 | 14.5% | VG |
| C20 | Example | Crystalline | 100 | Nanocrystal | 15 | 40.1 | 40.0 | 19.9 | 30.2 | 10.2% | 6.3% | G | 1110 | 14.7% | VG |
| F16 | Example | Crystalline | 100 | Nanocrystal | 15 | 20.4 | 60.0 | 19.6 | 29.6 | 12.6% | 5.4% | G | 820 | 13.6% | VG |
| F17 | Example | Crystalline | 100 | Nanocrystal | 15 | 3.9 | 76.2 | 19.9 | 29.8 | 13.3% | 5.8% | G | 610 | 6.5% | G |
| F18 | Example | Crystalline | 100 | Nanocrystal | 15 | 1.6 | 78.9 | 19.5 | 29.6 | 14.4% | 5.0% | G | 580 | 5.4% | G |

As shown in Table 5 and Table 6, in examples satisfying a relationship of T1>T2, even when changing a mixing ratio of the first large particles and the second large particles, DC bias characteristics better than the expected value were obtained, and the core loss could be reduced from the expected value by 5% or more. From these results, it could be understood that AL₁/A0 and AL₂/A0 can be arbitrarily set without a particular limitation.

From evaluation results of examples in Table 5, it could be confirmed that as the ratio of the amorphous second large particles increases, the core loss tends to be further lowered. That is, in a case where the crystalline first large particles and the amorphous second large particles are mixed, from the viewpoint of further lowering the core loss, AL₁/AL is preferably 60% or less, and more preferably 50% or less.

In addition, from evaluation results of examples in Table 6, it could be confirmed that when increasing the ratio of the nanocrystalline second large particles, the core loss tends to be further lowered, and when increasing the ratio of the crystalline first large particles, the variation rate of the magnetic permeability tends to be further decreased. That is, in a case where the crystalline first large particles and the nanocrystalline second large particles are mixed, it could be confirmed that from the viewpoint of further lowering the core loss, AL₁/AL is preferably 60% or less (more preferably 50% or less), and from the viewpoint of further improving the DC bias characteristics, AL₁/AL is preferably 40% or more (more preferably 50% or more). In addition, it could be confirmed that AL₁/AL is preferably 20% to 80% to make a low core loss and good DC bias characteristics be more appropriately compatible with each other.

### Experiment 5

In Experiment 5, magnetic core samples (Sample G1 to Sample G15) shown in Table 7 were manufactured by changing the ratio (AS/A0) of the small particles. In the respective samples in Experiment 5, the first large particles having the crystalline structure and the second large particles having the amorphous structure were mixed in a ratio of “1:1”. Manufacturing conditions other than the ratio of the small particles were set to be similar as in Experiment 2, and the magnetic permeability, the DC bias characteristics ((μi−μHdc)/μi), and the core loss were measured. Evaluation results are shown in Table 7.

TABLE 7

| | Example/ | First large particles | | Second large particles | | Total area ratio of metal |
|---|---|---|---|---|---|---|
| Sample | Comparative | Particle | Coating thickness | Particle | Coating thickness | magnetic particles |
| No. | Example | structure | T1 (nm) | structure | T2 (nm) | A0 (%) |
| G1 | Comparative | Crystalline | 15 | Amorphous | 100 | 75.4 |
| | Example | | | | | |
| G2 | Comparative | Crystalline | 15 | Amorphous | 15 | 75.3 |
| | Example | | | | | |
| G3 | Example | Crystalline | 100 | Amorphous | 15 | 75.2 |
| G4 | Comparative | Crystalline | 15 | Amorphous | 100 | 78.2 |
| | Example | | | | | |
| G5 | Comparative | Crystalline | 15 | Amorphous | 15 | 78.3 |
| | Example | | | | | |
| G6 | Example | Crystalline | 100 | Amorphous | 15 | 78.4 |
| B10 | Comparative | Crystalline | 15 | Amorphous | 100 | 79.3 |
| | Example | | | | | |
| B8 | Comparative | Crystalline | 15 | Amorphous | 15 | 79.4 |
| | Example | | | | | |
| B20 | Example | Crystalline | 100 | Amorphous | 15 | 79.4 |
| G7 | Comparative | Crystalline | 15 | Amorphous | 100 | 78.8 |
| | Example | | | | | |
| G8 | Comparative | Crystalline | 15 | Amorphous | 15 | 78.6 |
| | Example | | | | | |
| G9 | Example | Crystalline | 100 | Amorphous | 15 | 78.7 |
| G10 | Comparative | Crystalline | 15 | Amorphous | 100 | 78.1 |
| | Example | | | | | |
| G11 | Comparative | Crystalline | 15 | Amorphous | 15 | 78.3 |
| | Example | | | | | |
| G12 | Example | Crystalline | 100 | Amorphous | 15 | 78.5 |
| G13 | Comparative | Crystalline | 15 | Amorphous | 100 | 75.3 |
| | Example | | | | | |
| G14 | Comparative | Crystalline | 15 | Amorphous | 15 | 75.3 |
| | Example | | | | | |
| G15 | Example | Crystalline | 100 | Amorphous | 15 | 75.2 |

| | Mixing ratio of metal magnetic particles | | | Magnetic | | |
|---|---|---|---|---|---|---|
| | First large | Second large | Small | permeability | | |
| Sample | particles | particles | particles | μi | DC bias | Core loss |
| No. | AL₁/A0 (%) | AL₂/A0 (%) | AS/A0 (%) | (−) | characteristics | (kW/m³) |
| G1 | 51.6 | 48.4 | 0.0 | 20.1 | 18.1% | 2200 |
| G2 | 50.9 | 49.1 | 0.0 | 20.3 | 17.3% | 2050 |
| G3 | 50.5 | 49.5 | 0.0 | 20.4 | 8.7% | 1720 |
| G4 | 44.8 | 45.2 | 10.0 | 30.3 | 16.5% | 1980 |
| G5 | 44.9 | 45.3 | 9.8 | 30.6 | 15.5% | 1820 |
| G6 | 45.2 | 45.7 | 9.1 | 30.1 | 8.4% | 1550 |
| B10 | 41.5 | 40.9 | 17.6 | 30.4 | 17.3% | 1780 |
| B8 | 40.5 | 39.5 | 20.0 | 30.1 | 15.2% | 1610 |
| B20 | 40.9 | 40.2 | 18.9 | 31.0 | 7.9% | 1390 |
| G7 | 30.1 | 29.1 | 40.8 | 25.5 | 14.4% | 1320 |
| G8 | 30.3 | 29.5 | 40.2 | 25.3 | 13.8% | 1210 |
| G9 | 30.6 | 30.7 | 38.7 | 25.4 | 6.6% | 1000 |
| G10 | 20.5 | 20.3 | 59.2 | 20.3 | 11.5% | 890 |
| G11 | 18.8 | 18.3 | 62.9 | 20.4 | 10.8% | 750 |
| G12 | 18.5 | 19.0 | 62.5 | 20.7 | 6.5% | 650 |
| G13 | 10.7 | 11.2 | 78.1 | 15.4 | 9.6% | 480 |
| G14 | 10.2 | 10.1 | 79.7 | 15.2 | 9.7% | 420 |
| G15 | 10.3 | 10.4 | 79.3 | 15.3 | 4.8% | 360 |

As illustrated in Table 7, even when changing the ratio of the small particles, in examples in which T1/T2 is more than 1.0, DC bias characteristics better in comparison to comparative examples satisfying a relationship of T1≤T2 were obtained, and the core loss could be further reduced.

It could be confirmed that when increasing the ratio of the small particles in the magnetic cores, the core loss and the DC bias characteristics are further improved, and the magnetic permeability tends to decrease. It could be understood that the ratio (AS/A0) of the small particles is preferably 10% to 40% from the viewpoint of improving the core loss and the DC bias characteristics while securing high magnetic permeability.

Note that, in Experiment 5, in a case where the amorphous second large particles were used, but the crystalline first large particles and the nanocrystalline second large particles were mixed, similar tendency as in Experiment 5 could be confirmed.

### Experiment 6

In Experiment 6, magnetic core samples shown in Table 8 were manufactured by changing the packing rate (that is, A0) of the metal magnetic particles. The packing rate of the metal magnetic particles was controlled on the basis of an addition amount of an epoxy resin. The amount of the resin (the content of the epoxy resin with respect to the metal magnetic particles), and the total area ratio A0 of the metal magnetic particles in respective samples in Experiment 6 are shown in Table 8. Note that, in Sample H1 to Sample H9 shown in Table 8, the crystalline first large particles and the amorphous second large particles were mixed, and manufacturing conditions other than the amount of the resin, and the packing rate of the metal magnetic particles were set to be similar as in Experiment 2. Evaluation results in Experiment 6 are shown in Table 8.

TABLE 8

| | Example/ | First large particles | | Second large particles | | | Total area ratio of metal |
|---|---|---|---|---|---|---|---|
| Sample | Comparative | Particle | Coating thickness | Particle | Coating thickness | Amount of resin | magnetic particles |
| No. | Example | structure | T1 (nm) | structure | T2 (nm) | (parts by mass) | A0 (%) |
| H1 | Comparative | Crystalline | 15 | Amorphous | 100 | 1.0 | 89.3 |
| | Example | | | | | | |
| H2 | Comparative | Crystalline | 15 | Amorphous | 15 | 1.0 | 89.5 |
| | Example | | | | | | |
| H3 | Example | Crystalline | 100 | Amorphous | 15 | 1.0 | 90.0 |
| B10 | Comparative | Crystalline | 15 | Amorphous | 100 | 2.5 | 79.3 |
| | Example | | | | | | |
| B8 | Comparative | Crystalline | 15 | Amorphous | 15 | 2.5 | 79.4 |
| | Example | | | | | | |
| B20 | Example | Crystalline | 100 | Amorphous | 15 | 2.5 | 79.4 |
| H4 | Comparative | Crystalline | 15 | Amorphous | 100 | 3.5 | 75.1 |
| | Example | | | | | | |
| H5 | Comparative | Crystalline | 15 | Amorphous | 15 | 3.5 | 75.3 |
| | Example | | | | | | |
| H6 | Example | Crystalline | 100 | Amorphous | 15 | 3.5 | 75.0 |
| H7 | Comparative | Crystalline | 15 | Amorphous | 100 | 4.0 | 70.3 |
| | Example | | | | | | |
| H8 | Comparative | Crystalline | 15 | Amorphous | 15 | 4.0 | 70.1 |
| | Example | | | | | | |
| H9 | Comparative | Crystalline | 100 | Amorphous | 15 | 4.0 | 70.1 |
| | Example | | | | | | |

| | Mixing ratio of metal magnetic particles | | | Magnetic | | |
|---|---|---|---|---|---|---|
| | First large | Second large | | permeability | | |
| Sample | particles | particles | Small particles | μi | DC bias | Core loss |
| No. | AL₁/A0 (%) | AL₂/A0 (%) | AS/A0 (%) | (−) | characteristics | (kW/m³) |
| H1 | 39.5 | 39.7 | 20.8 | 38.1 | 14.1% | 1480 |
| H2 | 40.3 | 39.6 | 20.1 | 38.3 | 14.3% | 1460 |
| H3 | 40.0 | 39.5 | 20.5 | 38.6 | 8.4% | 1100 |
| B10 | 41.5 | 40.9 | 17.6 | 30.4 | 17.3% | 1780 |
| B8 | 40.5 | 39.5 | 20.0 | 30.1 | 15.2% | 1610 |
| B20 | 40.9 | 40.2 | 18.9 | 31.0 | 7.9% | 1390 |
| H4 | 40.2 | 40.1 | 19.7 | 25.1 | 14.4% | 1620 |
| H5 | 40.4 | 39.6 | 20.0 | 25.3 | 14.1% | 1610 |
| H6 | 40.4 | 40.1 | 19.5 | 25.1 | 8.4% | 1310 |
| H7 | 40.1 | 39.8 | 20.1 | 20.2 | 15.5% | 1580 |
| H8 | 39.6 | 39.5 | 20.9 | 20.2 | 15.7% | 1570 |
| H9 | 39.7 | 40.0 | 20.3 | 20.1 | 14.8% | 1470 |

As shown in Table 8, Sample H3, Sample B20, and Sample H6 are examples in Experiment 6, and A0 was within a range of 75% to 90%, and T1/T2 was 1.0 or more. In Sample H3, Sample B20, and Sample H6, the core loss is lower and the DC bias characteristics were better in comparison to corresponding to comparative examples. In Sample H9 in which A0 is less than 75%, T1/T2 was 1.0 or more, but the DC bias characteristics and the core loss were similar as in Sample H7 and Sample H8. As a result, it could be understood that the total area ratio A0 of the metal magnetic particles should be set to 75% to 90%.

In addition, in Sample H3 as an example, the magnetic permeability was higher and the core loss was lower in comparison to other examples (Sample B20 and Sample H6). That is, it could be understood that as the packing rate of the metal magnetic particles is made to be higher, the magnetic permeability μi becomes higher, and the core loss tends to further decreases, and thus A0 is more preferably 78% or more.

Note that, in Experiment 6, the amorphous second large particles were used, but even in a case where the crystalline first large particles and the nanocrystalline second large particles were mixed, similar tendency as in Experiment 6 could be confirmed.

### Experiment 7

In Experiment 7, magnetic core samples shown in Table 9 and Table 10 were manufactured by changing specifications of the small particles. Specifically, in Sample I1 and Sample I5 in Table 9, Fe—Ni-based alloy particles having an average particle size of 1 μm were used as the small particles, and in Sample I2 and Sample I6, Fe—Co-based alloy particles having an average particle size of 1 μm were used as the small particles. In Sample I3 and Sample I7, Fe—Si-based alloy particles having an average particle size of 1 μm were used as the small particles, and in Sample I4 and Sample I8, Co particles having an average particle size of 1 μm were used as the small particles. An insulation coating of Ba—Zn—B—Si—Al—O-based oxide glass having an average thickness of 15±10 nm was formed on any of the small particles. Manufacturing conditions other than the composition of the small particles in Sample I1 to Sample I4 were set to be similar as in Sample B20 in Experiment 2, and manufacturing conditions other than the composition of the small particles in Sample I5 to Sample I8 were set to be similar as in Sample C20 in Experiment 2.

In addition, in Sample J1 to Sample J4 in Table 10, two kinds of small particles different in a coating composition were added. Specifically, in Sample J1 and Sample J3, Fe particles (first small particles) on which a coating of Ba—Zn—B—Si—Al—O-based oxide glass was formed, and Fe particles (second small particles) on which an Si—O-based insulation coating was formed were mixed. In addition, in Sample J2 and Sample J4, Fe particles (first small particles) on which a coating of Si—Ba—Mn—O-based oxide glass was formed, and Fe particles (second small particles) on which an Si—O-based insulation coating was formed were mixed. In Sample J1 to Sample J4, an average thickness of the insulation coating of any of the small particles was within a range of 15±10 nm. Manufacturing conditions other than the above-described conditions in Sample J1 and Sample J2 were set to be similar as in Sample B20 in Experiment 2, and manufacturing conditions other than the above-described conditions in Sample J3 and Sample J4 were set to be similar as in Sample C20 in Experiment 2.

Evaluation results in Experiment 7 are shown in Table 9 and Table 10

TABLE 9

| | | First large particles | | Second large particles | | |
|---|---|---|---|---|---|---|
| | Example/ | | Coating | | Coating | Composition of |
| Sample | Comparative | Particle | thickness | Particle | thickness | small particles |
| No. | Example | structure | T1 (nm) | structure | T2 (nm) | |
| B20 | Example | Crystalline | 100 | Amorphous | 15 | Fe |
| I1 | Example | Crystalline | 100 | Amorphous | 15 | Fe—Ni |
| I2 | Example | Crystalline | 100 | Amorphous | 15 | Fe—Co |
| I3 | Example | Crystalline | 100 | Amorphous | 15 | Fe—Si |
| 14 | Example | Crystalline | 100 | Amorphous | 15 | Co |
| C20 | Example | Crystalline | 100 | Nanocrystal | 15 | Fe |
| 15 | Example | Crystalline | 100 | Nanocrystal | 15 | Fe—Ni |
| I6 | Example | Crystalline | 100 | Nanocrystal | 15 | Fe—Co |
| 17 | Example | Crystalline | 100 | Nanocrystal | 15 | Fe—Si |
| 18 | Example | Crystalline | 100 | Nanocrystal | 15 | Co |

| | Mixing ratio of metal magnetic particles | | | | | |
|---|---|---|---|---|---|---|
| | First large | Second large | Small | Magnetic | | |
| | particles | particles | particles | permeability | | |
| Sample | AL₁/A0 | AL₂/A0 | AS/A0 | μi | DC bias | Core loss |
| No. | (%) | (%) | (%) | (−) | characteristics | (kW/m³) |
| B20 | 40.9 | 40.2 | 18.9 | 31.0 | 7.9% | 1390 |
| I1 | 40.2 | 40.2 | 19.6 | 31.0 | 7.9% | 1310 |
| I2 | 40.1 | 40.0 | 19.9 | 30.8 | 7.8% | 1330 |
| I3 | 40.0 | 40.1 | 19.9 | 31.2 | 8.1% | 1340 |
| 14 | 40.0 | 39.9 | 20.1 | 31.1 | 8.2% | 1350 |
| C20 | 40.1 | 40.0 | 19.9 | 30.2 | 10.2% | 1110 |
| 15 | 40.2 | 40.2 | 19.6 | 31.0 | 10.3% | 1120 |
| I6 | 40.0 | 40.2 | 19.8 | 30.5 | 10.0% | 1100 |
| 17 | 40.0 | 40.1 | 19.9 | 31.2 | 10.4% | 1110 |
| 18 | 39.9 | 40.1 | 20.0 | 31.0 | 10.5% | 1140 |

TABLE 10

| | | First large particles | | Second large particles | | | |
|---|---|---|---|---|---|---|---|
| | Example/ | | Coating | | Coating | First Small particles | |
| Sample | Comparative | Particle | thickness | Particle | thickness | Particle | |
| No. | Example | structure | T1 (nm) | structure | T2 (nm) | composition | Coating composition |
| B20 | Example | Crystalline | 100 | Amorphous | 15 | Fe | Ba—Zn—B—Si—Al—O-based |
| J1 | Example | Crystalline | 100 | Amorphous | 15 | Fe | Ba—Zn—B—Si—Al—O-based |
| J2 | Example | Crystalline | 100 | Amorphous | 15 | Fe | Si—Ba—Mn—O-based |
| C20 | Example | Crystalline | 100 | Nanocrystal | 15 | Fe | Ba—Zn—B—Si—Al—O-based |
| J3 | Example | Crystalline | 100 | Nanocrystal | 15 | Fe | Ba—Zn—B—Si—Al—O-based |
| J4 | Example | Crystalline | 100 | Nanocrystal | 15 | Fe | Si—Ba—Mn—O-based |

| | | | Mixing ratio of metal magnetic particles | | | | Magnetic | | Core |
|---|---|---|---|---|---|---|---|---|---|
| | Second small particles | | First large | Second large | First small | Second small | permeability | DC bias | loss |
| Sample | Particle | Coating | particles | particles | particles | particles | μi | character- | (kW/ |
| No. | composition | composition | AL₁/A0 (%) | AL₂/A0 (%) | AS₁/A0 (%) | AS₂/A0 (%) | (−) | istics | m³) |
| B20 | — | — | 40.9 | 40.0 | 19.1 | — | 31.0 | 7.9% | 1390 |
| J1 | Fe | Si—O-based | 40.3 | 40.4 | 9.3 | 10.0 | 31.2 | 6.7% | 1350 |
| J2 | Fe | Si—O-based | 40.2 | 40.1 | 10.1 | 9.6 | 31.1 | 6.1% | 1360 |
| C20 | — | — | 40.1 | 40.0 | 19.9 | — | 30.2 | 10.2% | 1110 |
| J3 | Fe | Si—O-based | 40.0 | 39.8 | 9.3 | 10.9 | 30.1 | 9.1% | 1100 |
| J4 | Fe | Si—O-based | 40.2 | 39.9 | 10.1 | 9.8 | 30.2 | 9.3% | 1120 |

As shown in Table 9, even in Sample I1 to Sample I8 in which the composition of the small particles was changed, a low core loss and good DC bias characteristics were compatible with each other as in Sample B20 and Sample C20 in Experiment 2. From the results, it could be understood that in a case of adding the small particles to the magnetic cores, the composition of the small particles can be arbitrarily set without a particular limitation.

As shown in Table 10, In Sample J1 to Sample J4, the DC bias characteristics could be further improved in comparison to Sample B20 and Sample C20 in Experiment 2. From the result, it could be understood that when dispersing two kinds of small particles different in a coating composition in the magnetic cores, the DC bias characteristics can be further improved.

### Experiment 8

In Experiment 8, six kinds of magnetic core samples (Sample K1 to Sample K6) shown in Table 11 were manufactured by further adding medium particles in combination with the first large particles, the second large particles, and the small particles. Specifically, Fe—Si—B—Nb—Cu-based alloy particles in which an average particle size is 5 μm and which have the nanocrystal structure were added to the magnetic cores of Sample K1 and Sample K4 as the medium particles, Fe—Si-based alloy particles in which an average particle size is 5 μm and which have the crystalline structure were added to the magnetic cores of Sample K2 and Sample K5 as the medium particles, and Fe—Si—B-based alloy particles in which an average particle size is 5 μm and which have the amorphous structure were added to the magnetic cores of Sample K3 and Sample K6 as the medium particles. Note that, in any of the medium particles used in Experiment 8, D20 was less than 3 μm and D80 was 3 μm or more.

Manufacturing conditions other than the above-described conditions in Sample K1 to Sample K3 were set to be similar as in Sample B20 in Experiment 2, and manufacturing conditions other than the above-described conditions in Sample K4 to Sample K6 were set to be similar as in Sample C20 in Experiment 2. Evaluation results in Experiment 8 are shown in Table 11.

TABLE 11

| | Example/ | First large particles | | Second large particles | | | |
|---|---|---|---|---|---|---|---|
| Sample | Comparative | Particle | Coating thickness | Particle | Coating thickness | Structure of | |
| No. | Example | structure | T1 (nm) | structure | T2 (nm) | medium particles | |
| B20 | Example | Crystalline | 100 | Amorphous | 15 | — | |
| K1 | Example | Crystalline | 100 | Amorphous | 15 | Nanocrystal | |
| K2 | Example | Crystalline | 100 | Amorphous | 15 | Crystalline | |
| K3 | Example | Crystalline | 100 | Amorphous | 15 | Amorphous | |
| C20 | Example | Crystalline | 100 | Nanocrystal | 15 | — | |
| K4 | Example | Crystalline | 100 | Nanocrystal | 15 | Nanocrystal | |
| K5 | Example | Crystalline | 100 | Nanocrystal | 15 | Crystalline | |
| K6 | Example | Crystalline | 100 | Nanocrystal | 15 | Amorphous | |
| | Mixing ratio of metal magnetic particles | | | | Magnetic | | |
| | First large | Second large | Medium | Small | permeability | | |
| Sample | particles | particles | particles | particles | μi | DC bias | Core loss |
| No. | AL₁/A0 (%) | AL₂/A0 (%) | AM/A0 (%) | AS/A0 (%) | (−) | characteristics | (kW/m³) |
| B20 | 40.9 | 40.2 | 0.0 | 18.9 | 31.0 | 7.9% | 1390 |
| K1 | 39.7 | 39.7 | 10.1 | 10.5 | 31.1 | 7.5% | 1280 |
| K2 | 40.1 | 40.0 | 10.1 | 9.8 | 31.2 | 7.4% | 1420 |
| K3 | 40.4 | 39.9 | 10.3 | 9.4 | 31.1 | 7.4% | 1340 |
| C20 | 40.1 | 40.0 | 0.0 | 19.9 | 30.2 | 10.2% | 1110 |
| K4 | 40.2 | 39.7 | 10.0 | 10.1 | 30.1 | 9.8% | 1090 |
| K5 | 40.5 | 39.5 | 10.1 | 9.9 | 30.3 | 9.7% | 1310 |
| K6 | 40.1 | 40.1 | 10.2 | 9.6 | 30.4 | 9.6% | 1220 |

As shown in Table 11, even in Sample K1 to Sample K6 to which the medium particles were added, a low core loss and good DC bias characteristics were compatible with each other as in Sample B20 and Sample C20 in Experiment 2. From evaluation results in Experiment 8, it could be understood that the medium particles may be added to the magnetic cores, and in a case of adding the medium particles, it is preferable to use medium particles having the nanocrystal structure or the amorphous structure from the viewpoint of further lowering the core loss.

### Experiment 9

In Experiment 9, magnetic core samples were manufactured by mixing three kinds of large particles and one kind of small particles. Specifically, in Experiment 9, crystalline first large particles (the same Fe—Si alloy particles as in Experiment 2), amorphous second large particles, nanocrystalline second large particles, and small particles (the same pure iron particles as in Experiment 2) were mixed in ratios shown in Table 12, thereby obtaining three kinds of magnetic core samples (Sample L1 to Sample L3). Specifications (a particle composition, an average particle size, a coating composition, and the like) of the amorphous second large particles used in Sample L1 to Sample L3 were set to be the same as in the second large particles used in Sample B20 in Experiment 2. In addition, specification of the nanocrystalline second large particles used in Sample L1 to Sample L3 were set to be the same as in the second large particles used in Sample C20 in Experiment 2.

Experiment conditions other than the conditions were set to be similar as in Sample B20 and Sample C20 in Experiment 2. Evaluation results in Experiment 9 are shown in Table 12.

TABLE 12

| | | | | | | | | Mixing ratio of metal | |
|---|---|---|---|---|---|---|---|---|---|
| | | | | Second large particles | | Second large particles | | magnetic particles | |
| | | First large particles | | (Amorphous ) | | (Nanocrystal) | | | Second large |
| | Example/ | | Coating | | Coating | | Coating | First large | particles |
| Sample | Comparative | Particle | thickness | Particle | thickness | Particle | thickness | particles | Amorphous |
| No. | Example | structure | T1 (nm) | structure | T2 (nm) | structure | T3 (nm) | AL₁/A0 (%) | AL₂/A0 (%) |
| B20 | Example | Crystalline | 100 | Amorphous | 15 | — | — | 40.9 | 40.2 |
| C20 | Example | Crystalline | 100 | — | — | Nanocrystal | 15 | 40.1 | 0.0 |
| L1 | Example | Crystalline | 100 | Amorphous | 15 | Nanocrystal | 15 | 39.7 | 10.2 |
| L2 | Example | Crystalline | 100 | Amorphous | 15 | Nanocrystal | 15 | 40.1 | 20.0 |
| L3 | Example | Crystalline | 100 | Amorphous | 15 | Nanocrystal | 15 | 40.4 | 30.3 |
| | Mixing ratio of metal | | | | | | | | |
| | magnetic particles | | | DC bias characteristics | | | | | |
| | Second large | | Magnetic | | Difference | | Core loss | | |
| | particles | Small | permeability | Measured | from | | Measured | Improvement | |
| Sample | Nanocrystal | particles | μi | value | expected | | value | rate | |
| No. | AL₃/A0 (%) | AS/A0 (%) | (−) | (%) | value (%) | Determination | (kW/m³) | (%) | Determination |
| B20 | 0.0 | 18.9 | 31.0 | 7.9% | 5.7% | G | 1390 | 14.9% | VG |
| C20 | 40.0 | 19.9 | 30.2 | 10.2% | 6.3% | G | 1110 | 14.7% | VG |
| L1 | 30.4 | 19.7 | 31.1 | 7.5% | 8.3% | G | 1200 | 12.7% | VG |
| L2 | 20.3 | 19.6 | 31.2 | 7.4% | 7.6% | G | 1220 | 16.3% | VG |
| L3 | 10.3 | 19.0 | 31.1 | 7.4% | 7.0% | G | 1340 | 13.3% | VG |

As shown in Table 12, even in Sample L1 to Sample L3 in which three kinds of large particles were mixed, when an insulation coating of the crystalline first large particles is set to be thicker than an insulation coating of the second large particles (T1>T2, T1>T2), a low core loss and good DC bias characteristics were compatible with each other as in Sample B20 and Sample C20 in Experiment 2.

### Experiment 10

In Experiment 10, magnetic core samples shown in Table 13 and Table 14 were manufactured by changing the composition of the first large particles having the crystalline structure, and the composition of the second large particles having the amorphous structure or the nanocrystal structure. In any of the crystalline first large particles used in Experiment 10, the average particle size was 20 μm, the degree of amorphization was less than 85%, and the average crystallite diameter was 100 nm or more. In addition, in any of the amorphous second large particles used in Experiment 10, the average particle size was 20 μm, and the degree of amorphization was 85% or more. In addition, in the nanocrystalline second large particles used in Experiment 10, the average particle size was 20 μm, the degree of amorphization was less than 85%, and the average crystallite diameter was within a range of 0.5 to 30 nm.

Note that, a coating of P—Zn—Al—O-based oxide glass was formed on any of the crystalline first large particles, the amorphous second large particles, and the nanocrystalline second large particles used in Experiment 10.

Sample M1 to Sample M19 shown in Table 13 are comparative examples in which one kind of large particles and one kind of small particles (pure iron particles) were mixed, and in Sample M1 to Sample M19, the large particles and the small particles were mixed so that the ratio AS/A0 of the small particles becomes 20±2%. Manufacturing conditions of Sample M1 to Sample M19 are set to be similar as in Experiment 1 except that the composition of the large particles is different.

Note that, Sample N1 to Sample N19 shown in Table 14 are examples in which the first large particles having the crystalline structure, the second large particles having the amorphous structure or the nanocrystal structure, and the small particles (pure iron particles) were mixed. In Sample N1 to Sample N19, AL₁/A0 was 40±1%, AL₂/A0 was 40±1%, and AS/A0 was 20±2%. Manufacturing conditions of Sample N1 to Sample N19 were set to be similar as in Experiment 2 except that the composition of the first large particles, and/or the second large particles is different.

Evaluation results in Experiment 10 are shown in Table 13 and Table 14. Note that, in examples shown in Table 14, an expected value of the DC bias characteristics and an expected value of the core loss were calculated with reference to the evaluation results in the comparative examples shown in Table 13, and the quality of the DC bias characteristics and the core loss in the respective examples was determined.

TABLE 13

| | | Large particles | | | | | Mixing ratio of metal | | Magnetic | | |
|---|---|---|---|---|---|---|---|---|---|---|---|
| | Example/ | | | | Coating | Composition | magnetic particles | | permeability | DC bias characteristics | |
| Sample | Comparative | | | | thickness | of small | Large particles | Small particles | μi | (mi-mHdc)/mi | Core loss |
| No. | Example | Structure | Particle composition | Coating composition | (nm) | particles | AL/A0 (%) | AS/A0 (%) | (−) | (%) | (kW/m³) |
| A4 | Comparative | Crystalline | Fe—Si-based | P—Zn—Al—O-based | 100 | Fe | 78.6 | 21.4 | 30.2 | 13.3 | 1980 |
| | Example | | | | | | | | | | |
| M | Comparative | Crystalline | Fe-based | P—Zn—Al—O-based | 100 | Fe | 80.3 | 19.7 | 29.6 | 14.4 | 2110 |
| | Example | | | | | | | | | | |
| M2 | Comparative | Crystalline | Fe—Ni-based | P—Zn—Al—O-based | 100 | Fe | 79.5 | 20.5 | 29.8 | 14.4 | 1880 |
| | Example | | | | | | | | | | |
| M3 | Comparative | Crystalline | Fe—Si—Cr-based | P—Zn—Al—O-based | 100 | Fe | 80.3 | 19.7 | 30.1 | 14.2 | 1880 |
| | Example | | | | | | | | | | |
| M4 | Comparative | Crystalline | Fe—Si—Al-based | P—Zn—Al—O-based | 100 | Fe | 80.4 | 19.6 | 29.9 | 14.3 | 1580 |
| | Example | | | | | | | | | | |
| M5 | Comparative | Crystalline | Fe—Si—Al—Ni-based | P—Zn—Al—O-based | 100 | Fe | 79.7 | 20.3 | 29.9 | 14.3 | 1580 |
| | Example | | | | | | | | | | |
| M6 | Comparative | Crystalline | Fe—Ni—Si—Co-based | P—Zn—Al—O-based | 100 | Fe | 80.0 | 20.0 | 30.3 | 14.1 | 1680 |
| | Example | | | | | | | | | | |
| M7 | Comparative | Crystalline | Fe—Co-based | P—Zn—Al—O-based | 100 | Fe | 79.6 | 20.4 | 30.3 | 14.2 | 2200 |
| | Example | | | | | | | | | | |
| M8 | Comparative | Crystalline | Fe—Co—V-based | P—Zn—Al—O-based | 100 | Fe | 80.3 | 19.7 | 29.7 | 14.3 | 1800 |
| | Example | | | | | | | | | | |
| M9 | Comparative | Crystalline | Fe—Co—Si-based | P—Zn—Al—O-based | 100 | Fe | 80.1 | 19.9 | 29.9 | 14.1 | 1890 |
| | Example | | | | | | | | | | |
| M10 | Comparative | Crystalline | Fe—Co—Si—Al-based | P—Zn—Al—O-based | 100 | Fe | 79.6 | 20.4 | 29.8 | 13.3 | 1780 |
| | Example | | | | | | | | | | |
| A8 | Comparative | Amorphous | Fe—Co—B—P—Si—Cr-based | P—Zn—Al—O-based | 15 | Fe | 80.8 | 19.2 | 30.8 | 13.5 | 1210 |
| | Example | | | | | | | | | | |
| M1 | Comparative | Amorphous | Fe—Si—B-based | P—Zn—Al—O-based | 15 | Fe | 80.1 | 19.9 | 30.2 | 14.4 | 1200 |
| | Example | | | | | | | | | | |
| M12 | Comparative | Amorphous | Fe—Si—B—C-based | P—Zn—Al—O-based | 15 | Fe | 79.6 | 20.4 | 29.8 | 14.4 | 1210 |
| | Example | | | | | | | | | | |
| M13 | Comparative | Amorphous | Fe—Si—B—C—Cr-based | P—Zn—Al—O-based | 15 | Fe | 79.9 | 20.1 | 30.7 | 14.4 | 1240 |
| | Example | | | | | | | | | | |
| M14 | Comparative | Amorphous | Fe—Co—P—C-based | P—Zn—Al—O-based | 15 | Fe | 79.8 | 20.2 | 30.2 | 13.3 | 1320 |
| | Example | | | | | | | | | | |
| M15 | Comparative | Amorphous | Fe—Co—B-based | P—Zn—Al—O-based | 15 | Fe | 80.0 | 20.0 | 30.4 | 12.1 | 1440 |
| | Example | | | | | | | | | | |
| M16 | Comparative | Amorphous | Fe—Co—B—Si-based | P—Zn—Al—O-based | 15 | Fe | 80.4 | 19.6 | 30.7 | 12.2 | 1330 |
| | Example | | | | | | | | | | |
| A14 | Comparative | Nanocrystal | Fe—Si—B—Nb—Cu-based | P—Zn—Al—O-based | 15 | Fe | 79.8 | 20.2 | 30.2 | 19.3 | 580 |
| | Example | | | | | | | | | | |
| M17 | Comparative | Nanocrystal | Fe—Si—B—Nb—P-based | P—Zn—Al—O-based | 15 | Fe | 80.0 | 20.0 | 30.1 | 17.4 | 780 |
| | Example | | | | | | | | | | |
| M18 | Comparative | Nanocrystal | Fe—Co—B—P—Si-based | P—Zn—Al—O-based | 15 | Fe | 80.0 | 20.0 | 30.0 | 16.6 | 800 |
| | Example | | | | | | | | | | |
| M19 | Comparative | Nanocrystal | Fe—Co—B—P—Si—Cr-based | P—Zn—Al—O-based | 15 | Fe | 79.9 | 20.1 | 29.9 | 15.5 | 890 |
| | Example | | | | | | | | | | |

TABLE 14

| | | First large particles | | | Second large particles | | |
|---|---|---|---|---|---|---|---|
| | Example/ | | | Coating | | | Coating |
| Sample | Comparative | Particle | | thickness | Particle | | thickness |
| No. | Example | structure | Particle composition | T1 (nm) | structure | Particle composition | T2 (nm) |
| B20 | Example | Crystalline | Fe—Si-based | 100 | Amorphous | Fe—Co—B—P—Si—Cr-based | 15 |
| N1 | Example | Crystalline | Fe-based | 100 | Amorphous | Fe—Co—B—P—Si—Cr-based | 15 |
| N2 | Example | Crystalline | Fe—Ni-based | 100 | Amorphous | Fe—Co—B—P—Si—Cr-based | 15 |
| N3 | Example | Crystalline | Fe—Si—Cr-based | 100 | Amorphous | Fe—Co—B—P—Si—Cr-based | 15 |
| N4 | Example | Crystalline | Fe—Si—Al-based | 100 | Amorphous | Fe—Co—B—P—Si—Cr-based | 15 |
| N5 | Example | Crystalline | Fe—Si—Al-Ni-based | 100 | Amorphous | Fe—Co—B—P—Si—Cr-based | 15 |
| N6 | Example | Crystalline | Fe—Ni—Si—Co-based | 100 | Amorphous | Fe—Co—B—P—Si—Cr-based | 15 |
| N7 | Example | Crystalline | Fe—Co-based | 100 | Amorphous | Fe—Co—B—P—Si—Cr-based | 15 |
| N8 | Example | Crystalline | Fe—Co—V-based | 100 | Amorphous | Fe—Co—B—P—Si—Cr-based | 15 |
| N9 | Example | Crystalline | Fe—Co—Si-based | 100 | Amorphous | Fe—Co—B—P—Si—Cr-based | 15 |
| N10 | Example | Crystalline | Fe—Co—Si—Al-based | 100 | Amorphous | Fe—Co—B—P—Si—Cr-based | 15 |
| N11 | Example | Crystalline | Fe—Si-based | 100 | Amorphous | Fe—Si—B-based | 15 |
| N12 | Example | Crystalline | Fe—Si-based | 100 | Amorphous | Fe—Si—B—C-based | 15 |
| N13 | Example | Crystalline | Fe—Si-based | 100 | Amorphous | Fe—Si—B—C—Cr-based | 15 |
| N14 | Example | Crystalline | Fe—Si-based | 100 | Amorphous | Fe—Co—P—C-based | 15 |
| N15 | Example | Crystalline | Fe—Si-based | 100 | Amorphous | Fe—Co—B-based | 15 |
| N16 | Example | Crystalline | Fe—Si-based | 100 | Amorphous | Fe—Co—B—Si-based | 15 |
| C20 | Example | Crystalline | Fe—Si-based | 100 | Nanocrystal | Fe—Si—B—Nb—Cu-based | 15 |
| N17 | Example | Crystalline | Fe—Si-based | 100 | Nanocrystal | Fe—Si—B—Nb—P-based | 15 |
| N18 | Example | Crystalline | Fe—Si-based | 100 | Nanocrystal | Fe—Co—B—P—Si-based | 15 |
| N19 | Example | Crystalline | Fe—Si-based | 100 | Nanocrystal | Fe—Co—B—P—Si—Cr-based | 15 |

| | Magnetic | DC bias characteristics | | | Core loss | | |
|---|---|---|---|---|---|---|---|
| | permeability | Measured | | | Measured | Improvement | |
| Sample | μi | value | Difference from | | value | rate | |
| No. | (−) | (%) | expected value | Determination | (kW/m³) | (%) | Determination |
| B20 | 31.0 | 7.9% | 5.7% | G | 1390 | 14.9% | VG |
| N1 | 30.5 | 8.0% | 5.8% | G | 1350 | 17.9% | VG |
| N2 | 29.6 | 7.8% | 6.0% | G | 1300 | 14.8% | VG |
| N3 | 29.7 | 7.6% | 6.1% | G | 1280 | 16.3% | VG |
| N4 | 30.1 | 7.7% | 6.1% | G | 1150 | 16.7% | VG |
| N5 | 29.7 | 7.6% | 6.2% | G | 1180 | 14.7% | VG |
| N6 | 29.6 | 7.6% | 6.1% | G | 1180 | 17.9% | VG |
| N7 | 29.8 | 7.1% | 6.7% | G | 1480 | 13.4% | VG |
| N8 | 30.1 | 7.2% | 6.5% | G | 1190 | 19.6% | VG |
| N9 | 30.5 | 7.1% | 6.7% | G | 1200 | 22.4% | VG |
| N10 | 30.3 | 7.2% | 6.2% | G | 1200 | 19.9% | VG |
| N11 | 30.3 | 7.7% | 6.3% | G | 1330 | 17.5% | VG |
| N12 | 30.2 | 7.4% | 6.6% | G | 1340 | 16.7% | VG |
| N13 | 29.9 | 7.7% | 6.4% | G | 1380 | 16.1% | VG |
| N14 | 30.0 | 7.4% | 6.0% | G | 1390 | 16.8% | VG |
| N15 | 30.4 | 7.5% | 5.3% | G | 1420 | 17.6% | VG |
| N16 | 30.4 | 7.5% | 5.3% | G | 1380 | 17.5% | VG |
| C20 | 30.2 | 10.2% | 6.3% | G | 1110 | 14.7% | VG |
| N17 | 30.0 | 10.5% | 5.1% | G | 1190 | 15.7% | VG |
| N18 | 29.6 | 9.6% | 5.4% | G | 1180 | 15.5% | VG |
| N19 | 30.2 | 9.1% | 5.4% | G | 1180 | 18.5% | VG |

In any of the respective examples shown in Table 14, the DC bias characteristics could be improved from the expected value by 5% or more, and the core loss could be reduced from the expected value by 5% or more. From the results in Experiment 10, it could be understood that the composition of the first large particles and the second large particles can be arbitrarily selected without a particular limitation.

### EXPLANATIONS OF LETTERS OR NUMERALS

2 MAGNETIC CORE
10 METAL MAGNETIC PARTICLE
10a FIRST PARTICLE GROUP
11 LARGE PARTICLE
11a FIRST LARGE PARTICLE
11b SECOND LARGE PARTICLE
4 INSULATION COATING OF LARGE PARTICLE
4a INSULATION COATING OF FIRST LARGE PARTICLE
4b INSULATION COATING OF SECOND LARGE PARTICLE
10b SECOND PARTICLE GROUP
12 SMALL PARTICLE
12a FIRST SMALL PARTICLE
12b SECOND SMALL PARTICLE
6 INSULATION COATING OF SMALL PARTICLE
6a FIRST INSULATION COATING
6b SECOND INSULATION COATING
13 MEDIUM PARTICLE
20 RESIN
100 MAGNETIC COMPONENT
5 COIL
5a END PORTION
5b END PORTION
7, 9 EXTERNAL ELECTRODE

What is claimed is:

1. A magnetic core containing metal magnetic particles,
wherein a total area ratio occupied by the metal magnetic particles on a cross-section of the magnetic core is 75% to 90%,
the metal magnetic particles include,
first large particles comprising a crystalline metal material and having a Heywood diameter of 3 μm or more on the cross-section of the magnetic core, and
second large particles comprising a nanocrystal structure or an amorphous structure and having a Heywood diameter of 3 μm or more on the cross-section of the magnetic core, and
an insulation coating of the first large particles is thicker than an insulation coating of the second large particles.

2. The magnetic core according to claim 1,
wherein T1/T2 is 1.3 to 50, in which an average thickness of the insulation coating of the first large particles is set to T1, and
an average thickness of the insulation coating of the second large particles is set to T2.

3. The magnetic core according to claim 1,
wherein the average thickness T2 of the insulation coating of the second large particles is 5 to 50 nm.

4. The magnetic core according to claim 1,
wherein the metal magnetic particles include a particle group in which a Heywood diameter on the cross-section of the magnetic core is less than 3 μm, and
the particle group in which the Heywood diameter is less than 3 μm includes two or more kinds of small particles having coatings different in composition to each other.

5. A magnetic component comprising the magnetic core according to claim 1.
